(19) United States
(12) Patent Application Publication
(10) Pub. No.: US 2023/0183967 A1
(43) Pub. Date: Jun. 15, 2023

(54) SUB-DERMAL JOINTING FOR COMPOSITE PANELIZED BUILDING SYSTEM AND METHOD

(71) Applicant: DECOi Inc., Charlestown, MA (US)

(72) Inventor: Mark Goulthorpe, Charlestown, MA (US)

(21) Appl. No.: 18/080,731

(22) Filed: Dec. 13, 2022

Related U.S. Application Data
(60) Provisional application No. 63/289,052, filed on Dec. 13, 2021.
(60) Provisional application No. 63/289,029, filed on Dec. 13, 2021.
(60) Provisional application No. 63/289,036, filed on Dec. 13, 2021.

(51) Int. Cl. E04B 1/61; E04B 1/14; B32B 3/04; B32B 3/06

(52) U.S. Cl. CPC E04B 1/6145; B32B 3/04; B32B 3/06; E04B 1/14; B32B 27/36; E04B 2001/6195; E04B 2103/04

(57) ABSTRACT

Systems and methods are described herein for a panelized building assembly comprising a double skeleton of planar connectors, positioned parallel to and behind the inner and outer building surfaces of panels to be connected. The planar elements may be folded symmetrically about the bisected angle between adjacent surfaces so as to form a coherent and continuous double layer that can, in some cases, offers structural, fire, acoustical and waterproofing performance consistently between various panel. The connectors may extend into the mass of a block of material that forms a continuous edge around the perimeter of the panels, which is bonded continuously to the fiber-reinforced skin of the panel and to the core material that the inner and outer fiber reinforced skins are also continuously bonded to.

### CROSS REFERENCE TO THE RELATED APPLICATIONS

This application claims priority to U.S. Provisional Pat. Application No. 63/289,029, filed Dec. 13, 2021, entitled “COMPOSITE PANELIZED BUILDING SYSTEM AND METHOD,” U.S. Provisional Pat. Application No. 63/289,036, filed Dec. 13, 2021, entitled “INTEGRATED COMPONENTS AND SERVICES IN COMPOSITE PANELIZED BUILDING SYSTEM AND METHOD,” and U.S. Provisional Pat. Application No. 63/289,052, filed Dec. 13, 2021, entitled “SUB-DERMAL JOINTING FOR COMPOSITE PANELIZED BUILDING SYSTEM AND METHOD,” which are hereby incorporated herein by reference in their entirety and for all purposes.

### BACKGROUND

The predominant logic of current building construction involves the assemblage of multi-material, industrially-produced components, mainly comprised of minerals and metals (steel, concrete, aluminum, gypsum, copper, etc.). Implicitly such buildings are high mass and high energy-intensity, given the mining, purifying, smelting, baking, and other processes, etc. that they rely upon. This imposes a significant embodied energy footprint to such buildings, which at civilizational scale has portent of vast CO2 pollution given the anticipated doubling of buildings globally by 2050.

This late-industrial logic of assemblage of industrial readymade components means that buildings are comprised of thousands or tens of thousands of discrete parts, and implicit in this is a vast number of joints and mechanical connections. Inherently this means there will be differential thermal expansion between elements, with joints prone to leaking energy: a high in-use energy footprint. Current embodied and in-use energy consumption of buildings is some 40% of global energy production, before a doubling of global building stock. Basic physics dictates that buildings be low mass and low energy intensity to reduce their embodied footprint; and equally that buildings be few-joint, well-insulated, thin-skin assemblies, with a vast reduction in parts, materials, connections and cold bridges.

There is also an affordability crisis in the building sector, where the multi-trade, multi-material methods of the dominant building paradigm are imposing very high labor and logistical complexity that results in high cost. The sheer number of components and the dizzying choice they offer, has meant that the building sector has not increased its efficiency, despite computation. This contrasts with the manufacturing sector that has embraced new materials that lend themselves to CAD-CAM automation, witnessing a doubling of productivity.

In view of the foregoing, a need exists for an improved material-processing system and method for rapid manufacture and assembly of minimal environmental footprint buildings in an effort to overcome the aforementioned obstacles and deficiencies of conventional multi-material, multi-trade building systems.

### BRIEF DESCRIPTION OF THE DRAWINGS

Various techniques will be described with reference to the drawings, in which:

FIGS. 1A-1D illustrate different views of an example 9-panel building corner disassembled into polyfunctional composite structural panels and sub-dermal structural joining elements, in accordance with at least one embodiment;

FIG. 2 illustrates an example of supra-dermal adhesively-bonded structural tape used to close the joint at both inner and outer surfaces;

FIG. 3 illustrates an example diagram of a sub dermal joint, which may be used to connect two or more of building panels, in accordance with at least one embodiment;

FIG. 4 illustrates an example diagram of a multiple views of sub-dermal joining element used to bond two building composite panels, in accordance with at least one embodiment;

FIG. 5 illustrates an example of a sub-dermal joint in a 90-degree floor-to-wall or wall-to-wall or wall-to-ceiling corner, in accordance with at least one embodiment;

FIG. 6 illustrates another example diagram of a sub dermal joint, which may be used to connect two or more of building panels, in accordance with at least one embodiment;

FIG. 7 illustrates another example diagram of a sub dermal joint, including sub-dermal blocks with tapered internal corners to mitigate high stress concentrations in the core material, in accordance with at least one embodiment;

FIG. 8 illustrates two views of an example of a non-tapered corner connecting element for standard 90-degree connections between panels such as floor and two walls, or two walls and a ceiling, in accordance with at least one embodiment;

FIG. 9 illustrates of an example of a non-tapered corner connecting element for a 30-degree sloping connection between panels at a roof and two walls, in accordance with at least one embodiment;

FIG. 10 illustrates an example of a simple end connecting element for use at the end of a wall where the joint wraps from inner to outer skin, in accordance with at least one embodiment;

FIGS. 11A and 11B illustrate example views of an installation of the end connecting element of FIG. 10, in accordance with at least one embodiment;

FIGS. 12-14 illustrate different views of an example corner connecting element and a linear connecting element, in accordance with at least one embodiment;

FIG. 15 illustrate another example corner connecting element, in accordance with at least one embodiment;

FIGS. 16A-16E illustrate example diagrams of geometry of an example joint, in accordance with at least one embodiment;

FIG. 17 illustrates an example 7-panel assembly to form a corner that can meet the National Fire Prevention Association criteria for testing as a building assembly, in accordance with at least one embodiment;

FIGS. 18A-18O illustrate example stages in an example process to manufacture a wall panel, in accordance with at least one embodiment;

FIGS. 19A-19G illustrate example stages in an example process to manufacture a complex floor panel, in accordance with at least one embodiment;

FIGS. 20A-20J illustrate example topologies for various joints, in accordance with at least one embodiment;

FIGS. 21-22 illustrate more example topologies for various joints, in accordance with at least one embodiment;

FIGS. 23A-23H illustrate example stages in an example process to form a sub-dermal edge with internal connecting elements, in accordance with at least one embodiment;

FIGS. 24A-24F illustrate example stages in an example process to form an infused reinforced sub-dermal edge, in accordance with at least one embodiment;

FIGS. 25A-25N illustrate example stages in an example process to manufacture a building panel, in accordance with at least one embodiment;

FIG. 26 illustrates another example process for manufacture a building panel, in accordance with at least one embodiment;

FIG. 27 illustrates an example manufacturing facility that may be utilized to manufacture the descried building panels, in accordance with at least one embodiment; and

FIGS. 28A-28E illustrate example stages in an example fabrication process to manufacture a building panel, in accordance with at least one embodiment.

### DETAILED DESCRIPTION

In some examples, fiber-reinforced composites, including examples where fine structural fibers such as glass or carbon fiber are consolidated with a matrix material such as a polymeric resin to consolidate them spatially, can attain effective structural performance that compares favorably to wood or steel. By weaving such fibers and by orienting different orientations and woven or unidirectional fibers in layered and consolidated composites, in various examples their structural properties may be augmented and devised to be non-isotropic, allowing great structural versatility and performance that can be used in place of such traditional materials.

A particular advantage offered by fiber-reinforced composites in various embodiments can be the ability to manufacture thin structural skins, with a variety of methods allowing very large dimension in continuous structural sheets. Another advantage of some embodiments can be that by bonding such thin structural skins on either side of a lightweight core such as a polymeric foam, the thin skins can act like the flanges of a beam and the core like a low-density spatialized web, which in various examples can allow for efficient panelized beams where the fiber-reinforced skins can carry tension and compression and attain stiffness by virtue of their separation by the core, with stiffness increasing to the power of 4 relative to their separation in some example.

Since composite materials can be relatively expensive compared to traditional materials in some examples, as fibers and/or matrix resins can require sophisticated manufacturing in some instances, economy of material can be desirable in some embodiments of skin-core-skin composite structures. For example, the described skin-core-skin composite structures can use minimal amounts of relatively expensive materials to attain maximal structural performance. Yet the thin-skin morphology can have limitations in some examples, as loads can be carried in ultra-thin skins that can fail when highly stressed, such as when these skins are placed under compression where they tend to buckle, splitting off the lightweight core materials that can have limited tensile capacity. For this reason, cores like balsa or made of other various materials, oriented with the grain perpendicular to the fiber-reinforced skins, can be used in high stress structures like racing boats to limit skin buckling or wrinkling. However, this can add weight to the structure and can be an expensive material, so it may not be desirable in some embodiments.

Another disadvantage of some embodiments of thin-skin composite structures can be that joining one skin-core-skin panel to another can be technically challenging, as the skins can carry high but distributed load, spread through the fiber matrix, that may need transferring to the adjacent skin. Mechanical connections may be ineffective or undesirable in some examples as bolts or screws may create high load concentration points that chafe at the thin-skin fiber-based matrix, which in some embodiments can require local reinforcement to avoid the fibers simply being displaced locally and a hole or split developing. Some such structures can therefore prefer adhesive bonding over a large surface area, so that load transfers from one fiber/matrix sheet through the adhesive and into the next fiber-matrix sheet. This may be thought of in some examples as a “band aid”, functioning well so long as there is no prying load or moment that would peel off the tape as the adhesive itself has no fiber reinforcement. So taped joints can be effective at carrying in-plane loads in various embodiments, and in some examples such structures need to be engineered carefully to manage load flow to limit shear and bending at joints.

In some cases, adhesive taped jointing can require that both skins be bonded given that they may work structurally in concert - both tension and compression may need to be resolved at joints in various examples. By implication, various embodiments of such skin-core-skin composite structures may be thought of as not one but two monocoque structures, such that both skins carry load. At places where skin-core-skin panels join, in some examples, it can be desirable to provide a double joint, which in some embodiments can be attained by adhesive taping over the joint on both external surfaces, with the lightweight cores bonded together between skins to mitigate shearing that might pry the adhesive bond of the joining tapes.

Such taped joints can be difficult to apply in some embodiments, such as in various building use examples, as some such examples can require effective bonding over the total surface area of quite large-overlap tapes, and this can benefit in various embodiments from heat and pressure that can be difficult to apply in some examples given the general large size of panels and the need in some instances to bond large components out of a workshop environment. As a result, generally, composite manufacture – for example of boats, aircraft, wind turbine blades, etc. – can favor continuity of fiber-reinforced skins, such that a boat hull or aircraft fuselage is manufactured as a single skin-core-skin monocoque, or the like. Transportation of the large resulting elements can be difficult in various examples, sometimes requiring special transportation equipment, limiting routes that can be navigated, and involving road closures and police escorts that can be very expensive and restrictive.

Composites can be desirable in markets where large scale structures are required, such various examples as where strength-to-weight is an issue, as it can be with wind turbine blades, aircraft, boats and other markets where there can be benefit in performance. In cases were used for buses and trains, they can offer resilience against impact and light-weight for fuel economy. These applications can deploy composites as un-jointed double-skin monocoque structures, and in various examples they attain economy either via repetitive molding of standard parts and/or through lifetime economy in fuel savings. The internal bulkheads of boat hulls, or internal webs of wind turbine blades, for example, can be bonded via external tapes with adhesive overlap to transfer load between thin-skin elements. One-off designs for things like racing boats evidence the versatility that composites offer, but molded monocoques in various examples can require an expensive mold that can maintain vacuum pressure over a range of temperatures, so in various examples, economy can only be attained by serial manufacture, as in various examples of turbine blades, with no real possibility of variation of composite part.

In various embodiments, use of composites in the building sector can benefit from light-weighting and thermal performance offered by various examples of skin-core-skin insulated structural envelopes. For example, energy leakage in buildings can be from joints between components or via thermal bridging of studs and structural framing elements. Thin-skin composite buildings in various embodiments can reduce the embodied and in-use footprint of buildings, which can be desirable in the current context of CO₂ pollution and environmental change. Yet buildings can be idiosyncratic by nature, and generally far too large and odd-shaped to allow transportation as single monocoque entities. As such, there is need for a method of jointing large composite structural parts, such that they can be transported using typical road transportation to allow economy. Such multi-part composite assembly in various embodiments can allow versatility of building form but can require an effective and economical jointing system and method in various examples, and examples of some such effective and economical jointing system and method are shown and described herein.

Most typically, buildings are comprised of planar elements, with buildings and rooms generally of rectilinear form. Since this can correspond with an economical fiber-reinforced panel production, various embodiments herein can target jointing of planar large-format composite structural panels, allowing floors, walls, ceilings, roofs, fixed furniture, and many other planar elements, such as doors and screens, to be fabricated off-site, ready for easy flat-pack transportation and simple on-site jointing. However, these example embodiments should not be construed to be limiting and various non-planar and/or large and small format composite structural panels are within the scope and spirit of the present disclosure.

Various embodiments relate to non-standard manufacturing capability, meaning that either modular or one-off panels may be produced as needed, including various examples with some or all details integrated in the structural composite panels including various embodiments of the example jointing methodologies that are outlined below.

Such jointing can be sub-dermal rather than supra-dermal, such as occurring beneath each fiber-reinforced skin. This can have the benefit in various embodiments of allowing the joints to be invisible and to allow for pre-finished panels that are factory-finished to high standard without need for remedial filling, sanding and painting, as can be needed with various examples of an externally taped joint. Pre-finished panels on various embodiments can avoid the current logic of gypsum board finishing that can require taping/mudding/sanding and painting, generally 2 or 3 times. Various embodiments can eliminate or reduce this need by establishing an excavated cavity in a dense sub-dermal block of material that serves as a slot receptacle for adhesive bonding of a sub-dermal structural connection on one or both of its faces, allowing the (e.g., adhesive) bond to be half the length of anyone-side-bonded taped joint in some examples. These joints can occur where two planar composite panels may require jointing, which in various embodiments can establish a double monocoque structural envelope, but in a multi-panel assembly.

A vulnerability of some polymeric composites in buildings can be their fire performance, since various embodiments of a thin-skin structure can quickly get very hot under heat load, where just the radiant heat from a fire event can immediately raise temperatures of skins, adhesives and cores to high levels (assuming convection and conduction can be mitigated by physical means, such as intumescent coatings in various example). Given that various embodiments of fiber-reinforced structures can be comprised of polymeric matrices derived from hydrocarbons, which may degrade quite readily under heat insult, so any external (supra-dermal) taped structural joints can prove most vulnerable in various examples given their closest proximity to fire in a room or at a façade surface. Adhesives, (e.g., polymeric), can degrade as they get hot in various examples, so externally taped joints and their adhesive bond-line can degrade first in a fire event in some instances, which can be the inverse of what fire codes seek to achieve - that the base structure is the last thing to fail.

By displacing joints into sub-dermal cavities in dense, fire-retardant blocks, in various embodiments, adhesive and/or structural connection elements can be protected in the thermal shadow of such fire-retardant mass. In other words, the various embodiments described below can offer a system and method to create cost effective, code compliant jointing for planar composite building elements that can allow the benefits of lightweight and resilient composite structural panels to be used as a general building technology.

In view of the foregoing, a need exists for an improved jointing system and fabrication/assembly method for multi-panel, quasi-monocoque, composite building structures, in an effort to overcome the aforementioned obstacles and deficiencies of conventional building systems.

### Skin-Core-Skin Composites

The present disclosure in some aspects concerns a jointing system and method that in some embodiments allows fiber-reinforced composite structural panels to be connected together to create building enclosures and assemblies.

In various embodiments, composite structural panels can be comprised of fiber-matrix structural composite skins bonded to opposite sides of a core material panel such that the structural skins can act as the flanges of a large panel-size beam where the core acts as a web. By separating the two flanges, the core can allow the skins to carry tension or compression according to load, and stiffness can increase as a power of 4 in various examples per the distance the fiber-reinforced skins are separated.

The fibers in the various embodiments of structural skins can be glass fiber or carbon fiber or any other suitable load-carrying fiber, and they can be woven into sheets, or stitched together as unidirectional fibers, or accumulated by any suitable system or method to provide load-carrying capacity and resilience when consolidated with a matrix material. In some examples the matrix material can have no, or substantially no voids, and can serve to hold the fibers in their spatial arrangement and transfer load between them. The matrix material may be a polymeric resin such as epoxy or PET, or any other matrix that can function to inundate the fiber matrix fully and bond to the fibers to permit combinatory structural performance.

These composite structural skins can be built up from many layers of fiber in some embodiments, and the layers can be different fibers, different weaves, different densities such that the structural performance of the skins and hence the panels can be altered according to need or desire in a specific location, or for other suitable purposes. In other words, by varying the build-up of different fibers in various examples, such fiber-reinforced skins can offer a range of different performance capabilities. Where local stiffness or structural resilience is needed or desired, in some embodiments a strip or patch of fiber reinforcement can be added locally as needed or desired to provide adequate structural capacity at that particular location per building code or other performance criteria or for other suitable purpose.

The core material in various embodiments can be light weight to impose minimal additional load on the skins, which can be desirable in some embodiments given that various buildings can benefit from considerable stiffness to resist live loading, snow loading and wind loading, or the like. But the core material density and performance can be varied to suit performance requirements in a specific location, or for other suitable purpose. In some embodiments, a layer of acoustically absorptive core material may be bonded to a fire retardant core material and/or to a thermally insulating core material, each offering technical performance that augments the base panel material as needed, desired or for various suitable purposes.

Where there is considerable compressive load acting on a fiber-reinforced skin-core-skin composite panel, in some embodiments there can be a risk of skin buckling or wrinkling due to the thin-ness and relative flexibility of the skins that can pull away from or split various examples of low-density polymeric cores such as EPS or PET. To counter this, in some embodiments a more resilient core such as end-grain balsa wood or carbon foam or any other suitable core material can be used as a sub-dermal layer that resists fiber-reinforced skin deformation.

In some examples, the described techniques may include a panelized building assembly comprising a double skeleton of planar connectors, positioned parallel to and behind the inner and outer building surfaces. The planar elements may be folded symmetrically about the bisected angle between adjacent surfaces so as to form a coherent and continuous double layer that can, in some cases, offers structural, fire, acoustical and waterproofing performance consistently between every panel. The connectors may extend into the mass of a block of material that forms a continuous edge around the perimeter of every panel, which is bonded continuously to the fiber-reinforced skin of the panel that it is the edge of, and to the core material that the inner and outer fiber reinforced skins are also continuously bonded to.

In some cases, the edges may offer structural, fire, waterproofing and acoustical performance around all panel edges, inside and outside, and may be comprised of a single liquid that has solidified, or a series of linear solid elements, with or without fiber or other structural reinforcement. The connectors may be adhesively bonded or mechanically connected with sealants or gaskets to form a coherent and consistent barrier to water, sound, fire between inner and outer building surfaces.

Between the centerline of the inner and outer structural connectors, in some cases, there may be a structural material that connects the core of adjacent panels across the joint plane to permit shear load transfer between the cores that complements the load carrying capacity of the inner and outer connectors. This material may be an elastomeric adhesive, or in some cases a panel or section of a similar material as used for the skin elements. In some high-load cases, there may be additional material connecting the inner and outer connectors so as to permit them to act as a unitary structural element rather than as flanges of a beam co-jointed by the filler between the cores.

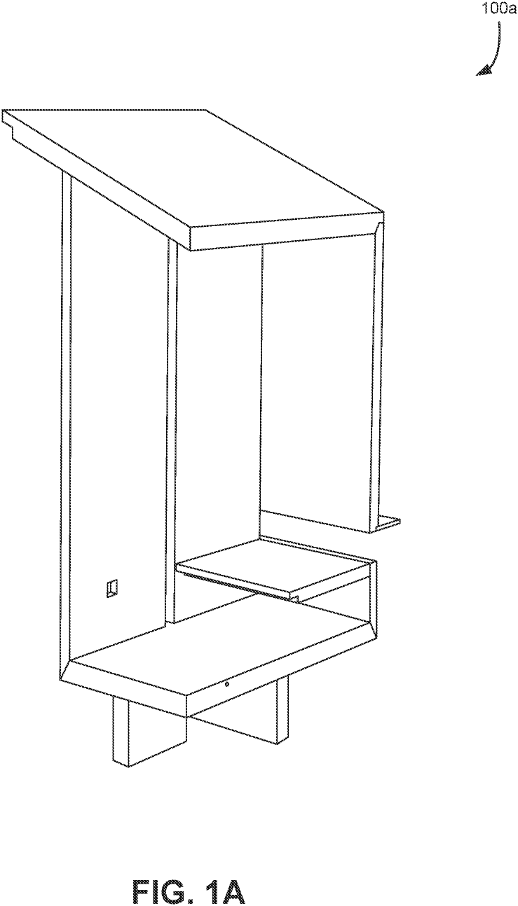

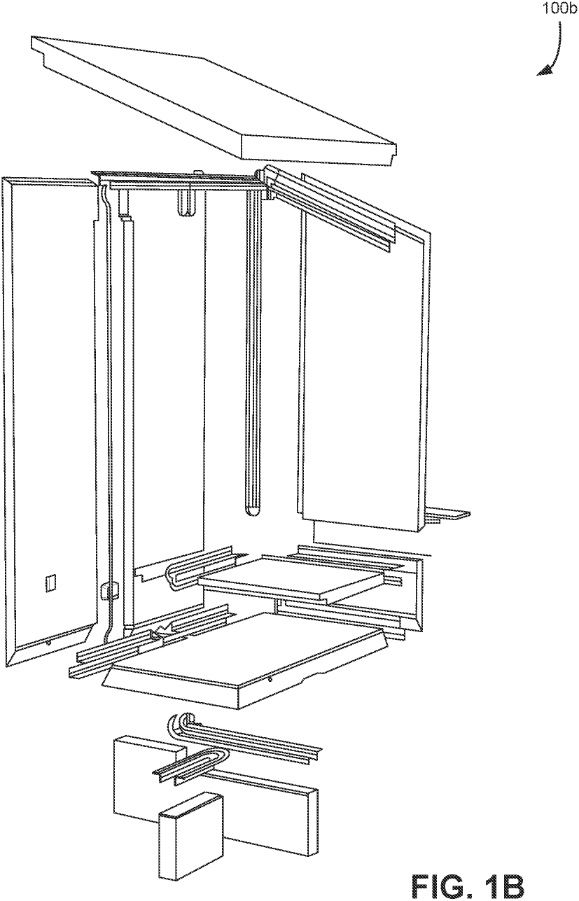

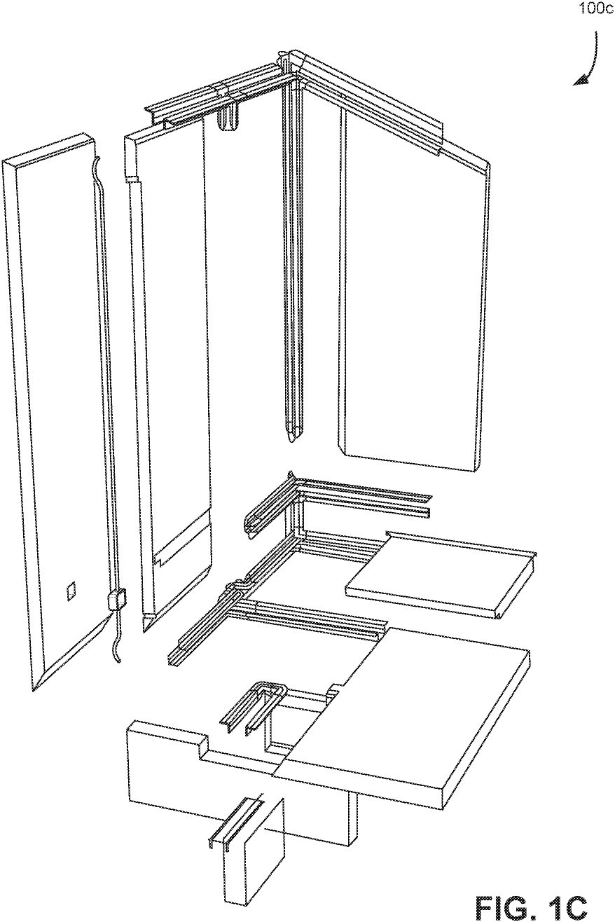

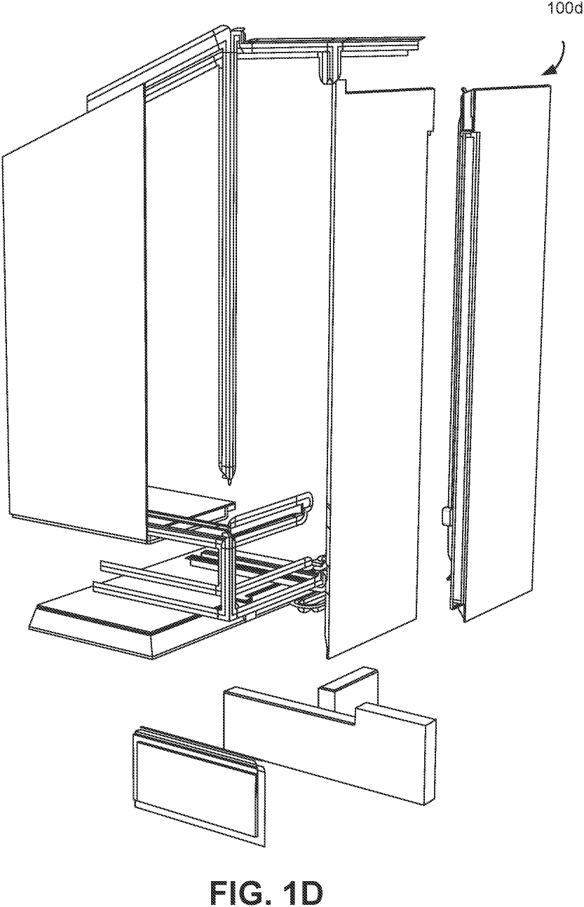

FIGS. 1A-1D illustrate different views 100a, 100b, 100c, 100d of an example 9-panel building corner disassembled into polyfunctional composite structural panels and sub-dermal structural joining elements, as may be designed and built using the techniques described herein. Using the described techniques to design and construct building panels and joining elements, various designs and structures may be realized. The design of joining elements and building panels, as described herein, can with only slight modification, be used to construct almost unlimited configurations of structures, as will be described in greater detail below. As illustrated view 100b, some or every joint in this example 9-panel building corner can adopt the same geometric logic and parameters, with some or every connecting element having the same sub-dermal distance below the fiber-reinforced skin, penetrating into a cavity in a sub-dermal block that can be a prescribed distance from the joint bisector plane as will be descried in greater detail below, in various examples regardless of whether panels are 180, 90 or any angle. This is one example of consistent jointing geometric logics being adopted in accordance with some embodiments.

As illustrated in diagram 100c, no two panels of the 9-panel assembly are the same, evidencing non-standard assembly. However, there is a coherent logic in the geometry of the sub-dermal connectors and the sub-dermal edge blocks that are cavitated to offer connection and protection to them. In these, the topology remains constant, with specific parameters such as angles and dimensions able to be varied. As illustrated diagram 100d another view of the same 9-panel building corner where 180-degree joints, 90 degree joints, 30-degree joints (roof), all follow the same geometric topology. Such ubiquitous jointing can allow a quasi-monocoque skin-core-skin structural logic using jointed panels, which can allow large-scale transportable building elements to be fabricated off-site to allow highly integrated manufacture of buildings. In various embodiments, structural jointing can enable an all-composite structural building envelope to offer building code compliant performance along some or every panel-to-panel connection, offering in various embodiments structural load-transfer, water tightness and weatherproofing, and thermal and acoustical performance.

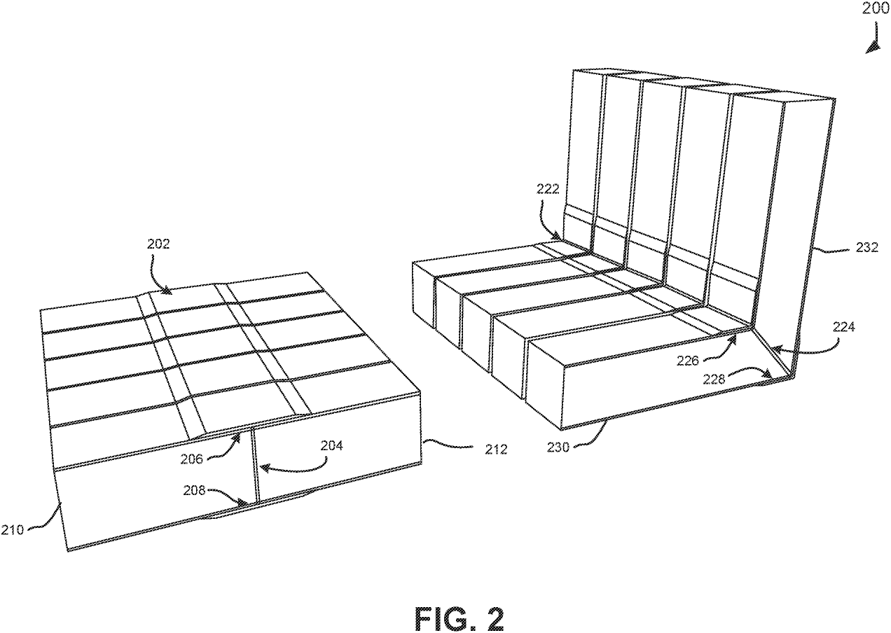

FIG. 2 illustrates an example diagram 200 of supra-dermal adhesively-bonded structural tape 202, 222 used to close the joints 204, 224 at both inner 206, 226 and outer surfaces 208, 228 of joined beams or panels 210, 212 and 230, 232. The supra-dermal tape 202, 222 can transfers load across a joint between two adjacent fiber-reinforced composite structural panels 210, 212, and 230, 232 with an elastomeric adhesive bond filling the gap between core material edges.

As a class of materials, fiber-reinforced structural composite skin-core-skin panels can offer highly efficient use of materials in various embodiments, attaining strength-to-weight advantage over many other structural assemblies owing in some examples to load being carried in very thin fiber “skins”, which in various embodiments can be of any suitable thickness , such as within the 1 mm-2 mm range, 2 mm - 4 mm range, 1.25 mm - 1.75 mm range, or the like. By virtue of two fiber-reinforced skins being (e.g., fully) bonded to a central separating core, in some embodiments such panels can perform well structurally by having high load concentration in the fiber/matrix skins. Since the fibers can extend in two or more directions across the (e.g., full) surface of the panel in various embodiments, a high load can get distributed along those fibers in various examples, but they can still be highly stressed structural elements relative to many typical materials in some embodiments.

Since buildings can be very large and complex spatial assemblies, there can be a need to join skin-core-skin panels together structurally to benefit from composite panels’ material efficiency. But given that the two skins work together, and that composites may attain greatest elegance in material use in monocoque structures in some embodiments, there can be a need to transfer load from inner to inner and from outer to outer fiber-reinforced skins, while at the same time attaining a transfer of shear load capacity from one low-density core to its adjoining low-density core.

In various embodiments, attaining effective load transfer from fiber-reinforced skin to fiber-reinforced skin can comprise adhesively bonding a broad strip of similar fiber-reinforced composite material across the joint on inner and/or outer surfaces. This can permit load transfer from skin fiber/matrix to adhesive to tape fiber/matrix, across the joint and from tape fiber/matrix to adhesive to skin/fiber matrix. The adhesive can allow loads to “flow” from one skin to the adjacent skins via an adhesive that is bonded over a quite large area to keep loading on the adhesive quite low. Another load transfer connection in various embodiments can be to bond core to core using an elastomeric adhesive that can be trapped between the external skin-to-skin tapes, filling the void between the low density, possibly multi-material core edges (to carry shear load).

However, in some embodiments, adhesive bonding of supra-dermal tapes across joints between fiber-reinforced panels may not lend itself to application on a building site, since heat and pressure can greatly benefit such a glued tape joint in various examples, and in various examples it may be difficult for these to be applied in the field. The aesthetic impact of taped joints may be undesirable in some examples for being detrimental to architectural finesse and may require remediation by mudding of the tapes (e.g., akin to taping gypsum board joints and then applying filler), then sanding such mudded regions flat, which can create dust and can require on-site finishing, all of these being detrimental in various examples to the high-quality off-site finishing that composites can allow.

In some embodiments, supra-dermal taping of joints can be undesirable because a structural connection (e.g., the tape), and the adhesive which bonds it to the exterior of the fiber-reinforced skin of a composite structural panel, can be in closest proximity to a potential fire either with a building (e.g., in a room) or at the facade of a building. In a fire event, conduction, convection and radiation can all occur, as well as buffeting by turbulence of hot gases and flame. Even when there is a robust protective coating to mitigate conduction, convection and buffeting, in various examples, radiant heat can tend to penetrate to the fiber-reinforced skins and adhesives and given their low mass and heat capacity in various examples, they can tend to get very hot quite quickly. Since typical fiber-reinforced structural composite panels can be comprised of polymeric resins, cores and adhesives, in some examples these can be vulnerable to degradation, liquification and gasification that tends to support vigorous combustion unless oxygen can be severely limited in some examples. The vulnerability of such supra-dermal taped structural connections can therefore be an ineffective strategy for some embodiments of composite buildings, being unlikely to offer good adhesion sufficient for structural connections, nor adequate fire retardancy except by significant defense of the composite skins and joints in various examples (e.g., by covering the composite assembly by a material such as gypsum board, which can obviate the use of composites by falling-back to multi-trade assembly on a building site).

The sub-dermal jointing method detailed here can offer in various embodiments an alternative solution that can address a need for affective adhesive bonding that minimizes time and labor in site assembly, and/or to provide defense of vital structural joints against radiant heat insult in a fire event. However, the following disclosure should not be construed to be limiting on the wide variety of further embodiments that are within the scope and spirit of the present disclosure.

### Example Sub-Dermal Jointing

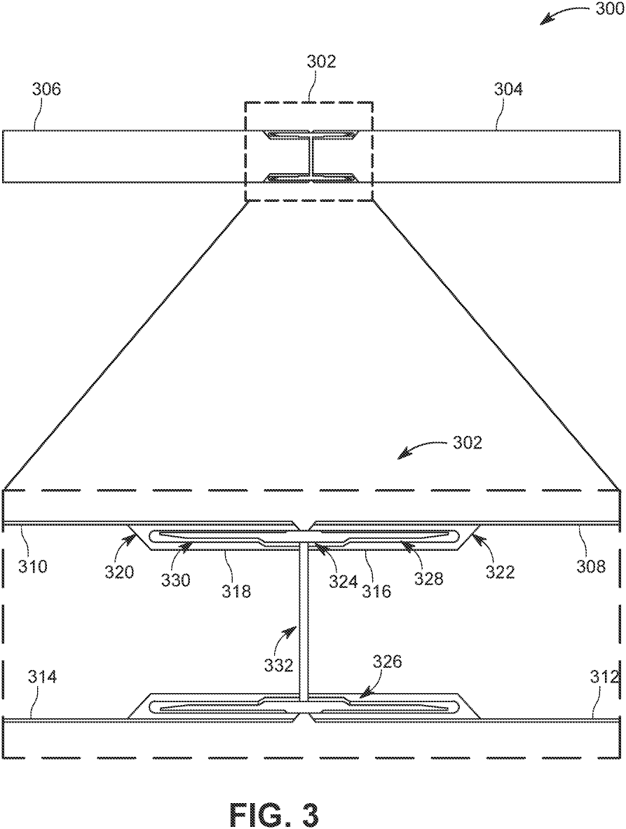

FIG. 3 illustrates an example diagram 300 of a sub-dermal joint 302, which may be used to connect two or more of the above-described panels 304, 306. For the sake of clarity, only one of joining elements 324, 326 will be described in relation to reference numerals below. It should be appreciated that joining element 326 and corresponding cavity may incorporate aspects of the joining element 324 and cavity described below, such as in a mirrored fashion.

Diagram 300 illustrates an example of a 180-degree panel-to-panel (or beam to beam) sub-dermal joint 302 showing (e.g., fiber-reinforced) structural skins 308, 310, 312, 314, solid sub-dermal edges 316, 318 with cavities 320, 322, structural sub-dermal joining elements 324, 326, adhesive 328, 330 in the cavities around the structural joining element 324, 326, and adhesive 332 between core edges between sub-dermal jointing elements 324, 326.

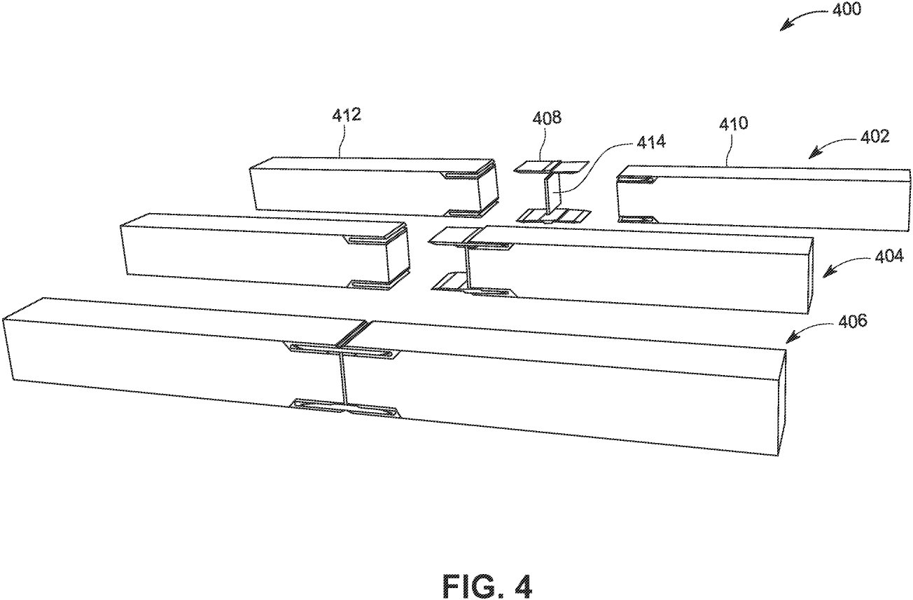

FIG. 4 illustrates an example diagram 400 of multiple views 402, 404, 406 of sub-dermal joining element 408 (e.g., adhesively) being bonded into a cavity in a sub-dermal mass bonded to the core and skin of each composite panel 410, 412. Sub-dermal joining element 408 may be an example of joining elements 324, 326 of sub-dermal joint 302 described above in reference to FIG. 3. In some examples, additional skin or reinforced material (e.g., the same or different than the skin material of the panels 410, 412) may be placed in between mating edges of the two panels 410, 412, as cross member 414 and bonded to each other and the mating edges, to further aid in joining the two panels and protecting the core material of the two panels. In other cases, a layer of adhesive, or material that bonds to the cores when formed, can be used as element 614, in place of a distinct skin material with separate adhesive. In some cases, element 614 mat be an adhesive layer allowing the two cores to transfer shear load between the cores of adjacent panels. In yet some cases, element 614 may function to seal off cores of the two panels from external environmental influences, increase fire safety, ad insulating properties, and the like.

In various embodiments, this technology involves sub-dermal jointing to connect together skin-core-skin fiber reinforced panels, whether structural or non-structural. By “sub-dermal” we mean that the joining occurs on the core side of one or more fiber-reinforced skins.

Each skin of a skin-core-skin fiber-reinforced panel can be connected to the corresponding skin on the adjacent panel in various embodiments, so there can be sub-dermal joints at some or every skin edge. The fiber-reinforced skins may be comprised of many different materials such as multi-layered fibers and matrix resins, and/or each panel may have different multi-material composites, so “skin” here in various embodiments can refer to a portion of, or an entire, load-carrying entity bonded to either face of a separating core material. The edge of one or more core material can be connected to the core in an adjacent panel, and a core panel that separates the two fiber-reinforced skins may be comprised of multiple materials such as PET and CFoam or any suitable combination of materials.

The sub-dermal joints can comprise the sub-dermal skin-to-skin jointing and the core-to-core jointing, which in some embodiments work together to attain the required or desired performance for use in buildings or for other suitable purpose.

The skin-to-skin joints on various embodiments can comprise at least one or at least two of the following elements. The first can be the actual connecting element, which can link one panel to the other, extending into the volume of one or both panels and bridging between them. The second can be a material block that can sit just below the fiber-reinforced skin of one or both panels along the edges of the fiber-reinforced skin, its top face in full or at least partial contact with and bonded to the back face of the fiber-reinforced skin of the composite panels in various embodiments, and its panel face and/or bottom face in full or at least partial contact with and bonded to the core material(s) in various embodiments.

The connecting element and the sub-dermal material block can be joined together to permit structural load to be transferred from one to the other. This joining may be achieved in some examples by mechanical means such as screws or bolts or any other suitable mechanism. Or in some embodiments, this joining may be achieved by adhesive bonding of the connecting element and the material block whether a glue or elastomer or any other suitable bonding material. The joining material and method can be deemed suitable in some embodiments when they meet the functional needs or desires for the joint in that specific location according to building code or other performance criteria, or for other suitable purpose.

To enable connection-of and load-transfer-between the connecting element and the sub-dermal material block, in various embodiments the material block can have an excavated cavity of the same form as, but slightly larger than, the connecting element, (e.g., such that the connecting element may be easily inserted into the cavity).

FIG. 5 illustrates an example diagram 500 of a 90-degree sub-dermal structural joint 502 that can follow the same or similar topology as the 180 degree joint (or any other angle), as described above in reference to FIGS. 3 and 4. In this example, edges of panels 508, 510 may be cut an angle to accommodate the 90 degree join (e.g., 45 degrees), whereby the sub-dermal edge may also be cut or otherwise constructed to match the angle of edge of the panel 508, 510.

In various embodiments, structural joining elements 504, 506 can establish a double skeleton structure (inner and outer) that runs sub-dermally under the edge of every or one or more fiber-reinforced structural skin edges of two panels 508, 510 where it is joined to a neighboring skin. In some examples, such a double skeleton not only provides structural connection, but also waterproofing, air-tightness, acoustical separation, resistance to insects, and/or prevents fire penetrating into the core of the panel, and other benefits. Where panels have a free-standing end, in various embodiments, the structural jointing element may wrap or cover the exposed end, fully or substantially closing the core in a ubiquitous manner such that there are no or substantially no gaps in the totality of the building envelope. In one example, the topology of the joint is everywhere the same, with the depth below the fiber reinforced skin, and the distance from the centerline of the joint being standardized. In one example, the cavity in the sub-dermal edges can be topologically standard and continuous, with internal corners radiused to maintain the depth of cavity from the centerline of the joint between the panels.

Another way to think of various embodiments of the sub-dermal structural joining elements would be to imagine a continuous structural strip taped externally between adjacent panel fiber-reinforced skins (like a “Band Aid” that runs everywhere across all panel joints and around all edges), but where that strip has sunk into the edges by a standard depth everywhere, so forming a sub-dermal rather than supra-dermal continuity. Such “sinking” can descend the structural strips below the fiber-reinforced skins and into the sub-dermal edges, which might be imagined as liquid when the strip sinks, but which then solidify around the strips. The advantage of sub-dermal jointing in some embodiments can be to attain fire retardancy by encasing the structural joints in a fire-retardant solid edge. Some such embodiments can allow panels to be fully or partially finished off-building-site in the workshop, since the connection of the panels in various embodiments can be hidden below the surface, not affecting the surface finish of the composite structural panels. Some such embodiments can allow a robust panel edge where the sub-dermal edge provides solid support to the fiber-reinforced skin, and can allow it to be finished precisely, for example using diamond-encrusted routing bits or endmills to cleanly sever the glass-fiber skins.

The structural joining elements of various embodiments can be linear since the panels of various examples are planar, and in one example they are planar strips where the tapered edges are co-planar (180 degrees) (as described above in reference to FIGS. 3-4) or hinged at right-angles (90 degrees) (as described above in reference to FIG. 5), since most buildings and rooms have orthogonal, rectilinear walls/floors/ceilings. These typical-angle structural joining elements can in some examples be pultruded fiber-reinforced linear elements, fully consolidated fiber/matrix composite elements engineered to carry load across joints as needed or desired to attain code-compliant performance of the quasi-monocoque structure or for other suitable purpose.

One example of a connecting element and cavity can include a flat pultruded fiber-reinforced linear plate, tapered at its edges, with the cavity then a negative slot in the sub-dermal block as if the surface of the connecting element had been offset outwards (e.g., by 1-2 mm) on some or all sides, with the offset form excavated from the sub-dermal block. The connecting element in various embodiments can then be freely inserted into the larger cavity, the (e.g., 1-2 mm) space available for an adhesive material to fill, and in some examples attaining a robust bonding-together to the two elements on one or both sides of the inserted connecting element.

In one example, a bead of glue deposited into the end of the excavated cavity can flow up between the sides of the connecting element and the sides of the sub-dermal cavity. If the bead were calibrated to contain the same volume as that of the (e.g., 1-2 mm V-shaped) gap, then the glue in various examples can extend up to the full depth of the cavitated slot, with various embodiments offering a robust adhesive bond of connecting element and sub-dermal material block, and with various examples providing guaranteed surface coverage. In another example, the connecting element and the sub-dermal material block can be mechanically connected, (e.g., with a gasket trapped and squeezed into the cavity or in any suitable place to offer water- and air-tightness). Another function of such gasket in some embodiments can be load-transfer from connecting element to sub-dermal block. In another example, the joining element may be shaped to snap or friction-fit into a cavitated slot, and in various embodiments transferring load (e.g., directly) from joining element to sub-dermal block.

The skin-to-skin jointing and the core-to-core jointing can in some embodiments together establish an effective sub-dermal joint, as in various examples it can be desirable for the core to resolve shear loads while the skin-to-skin jointing elements resolve tension and compression. At a location where there is a core edge of one panel adjacent to a core edge of another panel, these faces can be joined, for example to permit load transfer from core to core.

In one example this joint is 5 mm wide, with various embodiments allowing for realistic on-site tolerance in bringing panels together accurately, the gap between the cores filled with an elastomeric adhesive can allow the cores to transfer shear load from core to core through the adhesive. In another example, the cores can effectively butt together with a minimal gap between them, but in various examples the faces can be similarly bonded with an adhesive or other suitable coupling that has similar resiliency as the core materials, so the adhesive or other coupling flexes a similar amount under load.

### Example Sub-Dermal Material Block

In various embodiments, a sub-dermal material block fills a cavity in the core material under some or all edges of the fiber-reinforced skin, (e.g., fully) bonded to some or all adjacent materials, whether the fiber-reinforced skin or the core (which may comprise multi-materials), or both. In this way, in some examples the core and sub-dermal insert become (e.g., fully) integrated in a multi-material core panel, some or all materials bonded to some or all other materials. The sub-dermal block may be inserted into the cavity in the core materials in some embodiments as a series of solid blocks of material, cut (e.g., precisely) to shape to establish adjacency with core materials on some or all faces, and in various examples bonded to the core materials and/or to other sub-dermal blocks to form a coherent sub-dermal edge to the panel.

In various embodiments the sub-dermal block may be inserted into the cavity in the core materials as a liquid or paste or semi-solid material, and in some examples cured to form a solid that (e.g., precisely) fills the shape of the cavity to establish adjacency with core materials on some or all faces, and in various examples become bonded to the core materials and/or to other sub-dermal blocks to form a coherent and robust sub-dermal edge to the panel. As used herein, a semi-solid may refer to a paste, whereby the paste may be comprised of various materials, selected for specific performance attributes, including fire retardancy, water proofing, insulation properties, adhesion to different surfaces and different materials, and so on. As also described herein, any type of material, even those different than composites may be used to construct and form the various panelized building elements described herein, including various different aspects of panels, jointing elements, and so on, to a similar effect, including various metals, rubber, different type of plastic, organic material, and so on. The adhesives or gaskets used for these various materials may be selected to accommodate attributes of these materials.

The solid sub-dermal block, or the liquid, paste or semi-solid cured block, in various embodiments can extend at least to be co-planar with the outer surface of the core panel, which may be desirable to permit the fiber-reinforced skin to be bonded to a (e.g., absolutely) flat surface. Sanding, fly-milling or plaining the core and/or the sub-dermal solid block can attain (e.g., absolute) flatness, which can be desirable in various examples for full and consistent adhesion of the fiber-reinforced skin to the core-with- solid-edge integrated block panel.

In various embodiments, it can be desirable for there to be adequate bond length between the block and the fiber-reinforced skin, and/or between the joining element and the material block, to transfer load into and across the joint. In one example this would be a 70 mm overlap between the fiber-reinforced skin and the sub-dermal block and a 50 mm overlap in the cavity between the joining element and the sub-dermal block. But these example dimensions may be varied to suit the given needs or desires of a specific project or to meet building code or other technical performance requirements, or for other suitable purpose.

In one example the width of the sub-dermal block can be uniform throughout a given project, and/or the depth of the sub-dermal block can be uniform throughout a given project, which in various examples can offer benefit in design, engineering and manufacturing in being consistent. But these dimensional parameters may be varied in various embodiments.

### Example Excavated Cavity in Sub-Dermal Block

In various embodiments, it can be desirable for there to be adequate material in the sub-dermal block to permit a cavity to be excavated to accommodate the joining element, but in various examples still allowing enough remaining material in the block that, when bonded with the joining element, there can be enough structural capacity to transfer load into and across the joint. In one example the material block can be 20 mm deep, with the cavity 7 mm deep and 50 mm wide, the joining element then 5 mm deep and 48 mm wide with allowance for tolerance and adhesive thickness of 1 mm on some or all sides of the joining element. But these dimensions may be varied to suit the given needs or desires for a specific project or to meet building code or other technical performance requirements, or for other suitable purpose.

The sub-dermal block can in one example be cut, milled or routed along the external edge of the fiber-reinforced skin, allowing the overall panel to attain an accurate and robust exterior edge. In such an example, the sub-dermal block can be oversized relative to the final panel dimension such that there can be some tolerance for the cutting, milling or routing operation. In one example, the sub-dermal block can be oversized by 5 mm on these external faces, offering an excess of material to be trimmed-back to (e.g., exact) dimension, but in various examples also offering a solid sub-dermal support to the cutting, milling or routing operation, which can allow the fiber-reinforced skin to be cleanly severed in some examples, which can be difficult to do in some embodiments of fiber-reinforced composites. In other words, by having an oversized sub-dermal mass, in various embodiments the clean-severing of the fiber-reinforced skin can be aided, as the skin can be held firmly (e.g., to limit vibration or movement as the cutting tool impacts the material). In one example a diamond-encrusted endmill or router can be used to make this first clean cut, attaining a crisp and accurate edge to the fiber-reinforced panel.

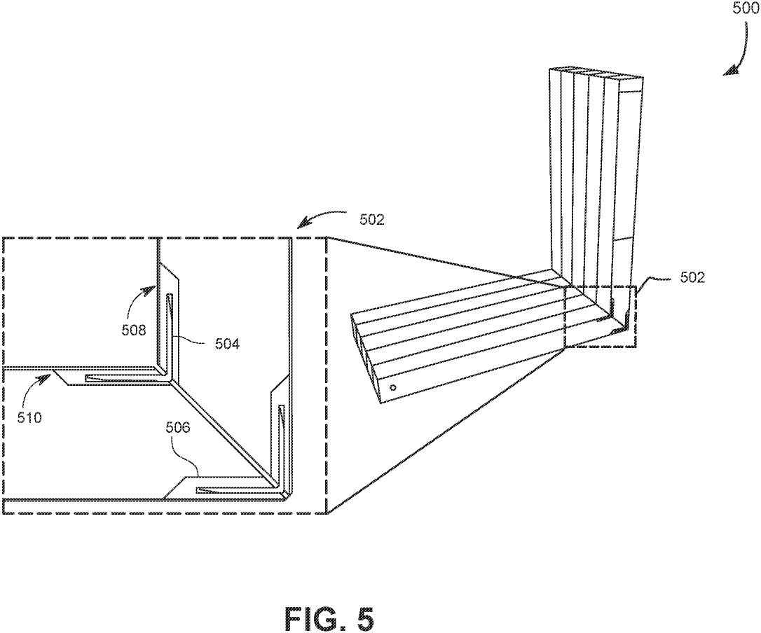

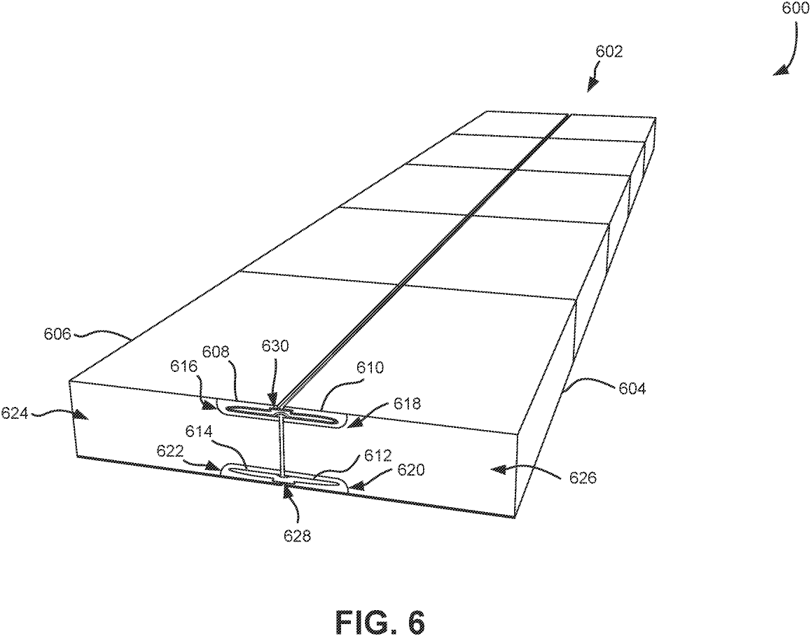

FIG. 6 illustrates another example diagram 600 of a sub dermal joint 602 between two panels 604, 606. More specifically, diagram 600 illustrates an example of sub-dermal blocks 608, 610, 612, 614 with rounded internal corners 616, 618, 629, 622 to mitigate high stress concentrations in the core material 624, 626. The drawing also shows an example of the sub-dermal connecting elements 628, 630 (e.g., adhesively) bonded into cavities in the sub-dermal blocks, and a layered fiber lamination build-up of the joining elements.

The excavated cavity can be formed in various embodiments by any suitable method such as casting or molding, but to ensure accuracy in some examples it may be created by cutting, milling or routing in a subsequent operation from the trimming, cutting or routing of the perimeter edge of the fiber-reinforced panel. When it is cut, milled or routed in some examples the excavated cavity may be disc-cut or endmill-routed, but discs in various embodiments can clear out dust and debris out of the area being cut due to the high-speed rotation, so they offer clean, debris-free cavitation at high speed.

At internal corners of polygonal panels, such as the inner corner of an L-shaped panel, in various examples disc and endmill cavitation can tend to create a radiused inner corner as the shaft of the tool cannot get in close due to the panel edge. In various embodiments, the cavity can be the negative of the tool that formed it, and the connecting element can be fabricated to match that (e.g., exact) circular shape whether by casting or molding or by 3D-printing or other suitable method. Typical internal corner conditions of some examples can lend themselves to mass production of connecting elements, while atypical or unique internal corners in some examples can be 3D-printed or produced by any suitable systems or method to attain a particular form with space for tolerance and adhesive bonding.

The sub-dermal edge blocks may be a rectangular form with parallel faces, but if so, then in some embodiments the load concentrations at the inner corners of the edge block where it is bonded into the core materials may be high. When the fiber-reinforced skin is loaded, in various examples the sub-dermal block can have a tendency to rotate as load is applied eccentrically to just its upper face, and this may in some examples translate high load to such an internal corner. For this reason, in various embodiments the sub-dermal block may have a chamfered or rounded internal corner where it is bonded to the core materials, mitigating a high load concentration. A tapered inner edge to the sub-dermal block, getting thinner towards the fiber-reinforced skin as it moves away from the panel edge in some examples, can permit load to be distributed from skin-to-block more gradually, which in various embodiments can minimize the risk of high load concentration.

As noted, when the fiber-reinforced skin is loaded, in various embodiments the sub-dermal block can have a tendency to rotate as load is applied eccentrically to just its upper face. To mitigate this, in some examples the sub-dermal blocks may be linked across the core to the sub-dermal block on the other side of the skin-core-skin composite panel. This linkage can in various embodiments offer support at the internal corner of the sub-dermal blocks, where rotation of both blocks, one under the inner fiber-reinforced skin and one under the outer fiber-reinforced skin, can tend to balance each other out. In some embodiments it can be desirable for such block-to-block linkage to have tension and compression capability, so bonding (e.g., fully) to both blocks with a material that has adequate structural capacity. In one example the linking element can be a metal screw that attaches to both blocks to hold them in place securely under tension or compression. In another example it would be the same liquid, paste or semi-solid material used for the blocks, applied into cavities in the core that link the two blocks, establishing a coherent material mass joining inner and outer sub-dermal blocks via a connecting through-core element. In some instances of this latter case, the through-core connector can have sufficient fiber or bead reinforcement to attain tension and compression structural capacity, adequate to building code or other functional requirements or desires for the specific building and location or for other suitable purpose.

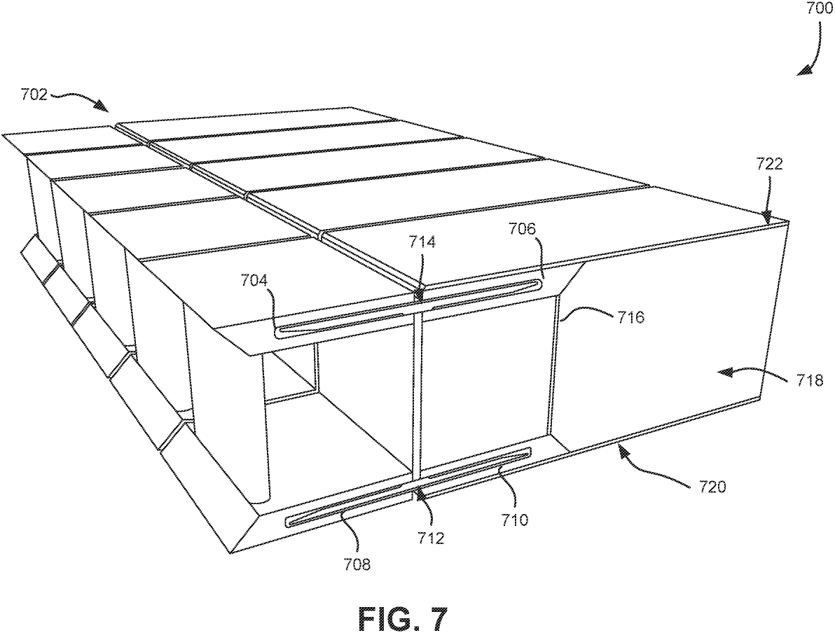

FIG. 7 illustrates another example diagram 700 of a sub dermal joint 702, including sub-dermal blocks 704, 706, 708, 710 with tapered internal corners to mitigate high stress concentrations in the core material. Diagram 700 illustrates an example of the sub-dermal connecting elements 712, 714 (e.g., adhesively) bonded into cavities in the sub-dermal blocks 704, 706, 708, 710, and block-to-block through-core connecting fins 716 to prevent rotation of the blocks in the core material. 718.

In various embodiments, it can be desirable for one or more connecting elements between inner and outer sub-dermal blocks to be (e.g., fully) bonded to the core materials whether mechanically, for instance by continuous screw thread, or by adhesive bonding, or by direct bonding of a liquid, paste or semi-solid curing (e.g., to form a cohesive multi-material mass with the core).

The sub-dermal block-to-block connection 716 may be of any suitable shape or size or direction or distribution according to the specific structural need or desire for that location or for other suitable purposes. In one example, the connection 716 may comprise one or more circular columns (e.g., every few inches) perpendicular to the fiber-reinforced skins 720, 722. In another example, it may comprise a thin fin of material several inches long, (e.g., occurring every couple of feet), perpendicular to the fiber-reinforced skins 720, 722. In another example the connecting element can be a continuous fin, but in some such cases the core can be severed, so may require bonding-back into the core panel in various embodiments. In another example, such columns or fins may be at a diagonal angle of 45 degrees or other suitable angle, as might suit reinforcement in a 90-degree corner where the sub-dermal blocks can be displaced by 45 degrees on the inner and outer fiber-reinforced skins. In another example, the connectors between blocks can comprise fins oriented perpendicular to the panel edge (e.g., being ½″ wide and spaced every 6″). In various such examples, the dimensions and/or spacing of the connecting elements may be varied in various suitable ways to attain adequate structural performance suitable for a specific location or building to meet building code or other functional requirements, or for other suitable purpose.

In very high load conditions for example, it may be desirable for a fiber-reinforced braid or other suitable continuous fiber sleeve or sheet to be inserted into the block-to-block connection 716, but in some examples in a manner that can ensure continuity of fiber into the two blocks. In one example, a (e.g., slightly oversized) tubular fiber-reinforced braid can be inserted into a milled circular cavity in the core material, and the ends of the braid can be flared to attain fiber in the base of each sub-dermal cavity; and in various examples, the two cavities and the milled hole can be filled with liquid, paste or semi-solid in a suitable manner (e.g., that inundates around the fibers of the braid in both cavities and/or in the linking column). In another example, one or more sheets of (e.g., slightly overlong) woven fiber sheet can be inserted into a milled linear slot in the core and the fibers folded over into the cavities, and in some examples before inundating both cavities and the connecting slot in a manner that (e.g., fully) infiltrates the fiber reinforcement. The goal of some embodiments can be to attain a high degree of structural capacity that stabilizes the sub-dermal blocks relative to the core materials and the fiber-reinforced skins.

The inner and outer sub-dermal blocks may be linked by a connecting element 716 on one or more non-connected edges of the panel. This can occur in some examples whenever or at least in some instances where a wall ends without connection to another panel, for example in order to close off the vulnerable core material with a solid mass that offers adequate resiliency, fire retardancy, weather-proofing and/or other needs to meet building codes or other functional requirements or for other suitable purpose. In some embodiments where the panel links to an adjacent panel, such connection(s) can follow the examples of the inner block-to-block connectors, being for example circular columns or thin fins with any suitable size or shape or spacing as needed or desired to further consolidate the sub-dermal blocks or for other suitable purpose. In some embodiments, such elements may only be required or necessary or desirable in very high-load situations.

In various embodiments, it can be desirable for material used for the sub-dermal blocks to be able to bond to the fiber-reinforced skin and/or the core materials, for example adhesively if the blocks are solid, or by adhesion of the liquid, paste or semi-solid material as it cures. Since some fiber-reinforced composites can be comprised of hydrocarbon-derived polymeric resins, polymeric adhesives and/or polymeric foams, and in various examples use of a hydrocarbon-derived material for the sub-dermal blocks can help compatibility with the adjoining materials, which can be desirable in some embodiments. One example would be to use an epoxy resin that readily allows for fire retardant additives or structural reinforcement or any other suitable modifiers to allow it to meet building code or any other functional requirements or for other suitable purpose. Since the sub-dermal blocks, which may be trimmed in various examples to give a precise edge to the panel, can then be exposed to the exterior, in various embodiments issues of weather-proofing, resilience against wear and tear, insect resistance, UV resistance, fire retardancy, and other needs or desires can make it desirable for just such a versatile and adaptable material as epoxy, although it could be any suitable material in further embodiments.

In one example where the sub-dermal block is a liquid, paste or semi-solid, it may be deployed into cavities in the core material by a mechanical pump via a nozzle, and in various examples with the core acting as a dam for the material to flow up against and solidify as it cures. Deployment of a liquid, paste or semi-solid material can allow that additive and the chemical composition be added differently in different locations, and in some embodiments allowing that its fire retardancy, or structural performance, or resiliency can be altered, in one example offering gradation of properties. In various embodiments, it can be desirable for such a change of properties to meet building codes or other performance criteria according to the functional need or desire in that specific location, or for other suitable purpose.

### Example Connecting Elements

In various embodiments a connection between adjacent fiber-reinforced panels can be created by several connecting-elements. Linear connecting-elements can join panel edges along their length in some embodiments, but at corners in some embodiments there may be corner connecting-elements. In one example, the linear connecting-elements may be cut at the bisected angle to be coupled (e.g., adhesively butt-jointed) to the next linear joining element cut to the same angle, (e.g., as in a picture frame). In another example, there can be independent corner connecting-elements used to join panels at their corners, whether for internal or external panel corners. This latter example in some embodiments can benefit from avoiding adhesive joints at bisected corners, which in some examples can be tricky to get accurate and fully bonded, and instead displaces the joint away from the corner, allowing that it be a simple orthogonal butt-joint between the linear connecting-element and the corner connecting-element.

In various embodiments, connecting-elements, whether linear or corner, can be adhesively bonded together. Where connecting elements need to be jointed along their length, then in some examples they can be adhesively bonded between clean orthogonal cut ends of same-section profiles to form an effective single continuous element. This can be desirable in some embodiments to avoid water or air penetration, and insect ingress, or the like. In some embodiments where corner elements are bonded to linear ones, the joints can be orthogonal clean cuts some distance from the corner. In various examples this can be easier and less prone to leakage than bisected corner joints.

In various embodiments, connecting-elements, as many as may be necessary or desired, can be (e.g., adhesively) bonded to form a continuous joining element that surrounds some or every panel on one or both inner and outer faces, providing in some examples a desirable barrier to air, water, weather, insects and/or fire ingress, or the like. In various embodiments, a double barrier can offer excellent building envelope performance, and in some examples especially when the connecting-elements are adhesively bonded to the sub-dermal blocks, as this in some instances can form a continuous and coherent composite materiality that effectively has no (or substantially no) gaps or joints. In various embodiments, inner and outer connecting-elements can be attached to the sub-dermal blocks of both the two adjacent panels by overlapping the connecting-element and the sub-dermal blocks within the excavated cavities in each block.

Simple corners such as 90-degree orthogonal junctions can occur in many places given that most rooms and buildings are orthogonal, so in various embodiments such corners may be formed via mass-production methods such as resin transfer molding (RTM), or the like. The form of these can be to extend exactly or substantially the same cross section as some or all the individual connecting-elements that run into the corner but fused into one un-jointed corner element.

Less typical or unique corner connecting-elements, for instance those with non-orthogonal angles, or where two corners occur directly adjacent to each other, may be less appropriate to be mass produced in some embodiments. So atypical corners can be produced by method such as 3D printing in some examples, (e.g., as if the linear connecting-elements had been extended into the corner and fused together).

Corner connecting-elements of various examples do not carry high structural load, so they can have less stringent need to have engineered fiber laminates as linear connecting-elements may in some embodiments. For this reason, fiber-reinforced 3D prints, whether with continuous-fiber 3D prints or short-strand reinforced 3D prints can both prove adequate to such occasional atypical corner connecting-elements in accordance with various embodiments.

In various embodiments, it can be desirable for linear connecting-elements to be of sufficient structural capacity as to carry the skin-to-skin loads per building codes or other performance criteria or for other suitable purpose. In one example, the connecting-elements can be metal, such as aluminum, but in some examples, metals can suffer different thermal expansion than composites, so can tend to separate over time from the composite sub-dermal blocks in some examples unless the adhesives are slightly elastomeric. In another example, the connecting-elements can comprise fiber-reinforced pultrusion’s, and these can benefit from similar thermal expansion as the other fiber-reinforced elements in some examples, but in various instances also offering different structural properties according to the lay-up for the fibers. However, any suitable material that allows sufficient structural capacity within a given size and shape of connecting-element may be used in various embodiments, so long as it can be adequately attached to the cavity of the sub-dermal blocks to attain building code compliance or meets any other technical performance criteria or for other suitable purpose.

FIG. 8 illustrates two views 800a, 800b of an example of a non-tapered corner connecting element 802 for standard 90-degree connections between panels such as floor and two walls, or two walls and a ceiling. In the example connecting element 902, inner and outer corner connecting-elements can be identical in various embodiments, such as when not tapered.

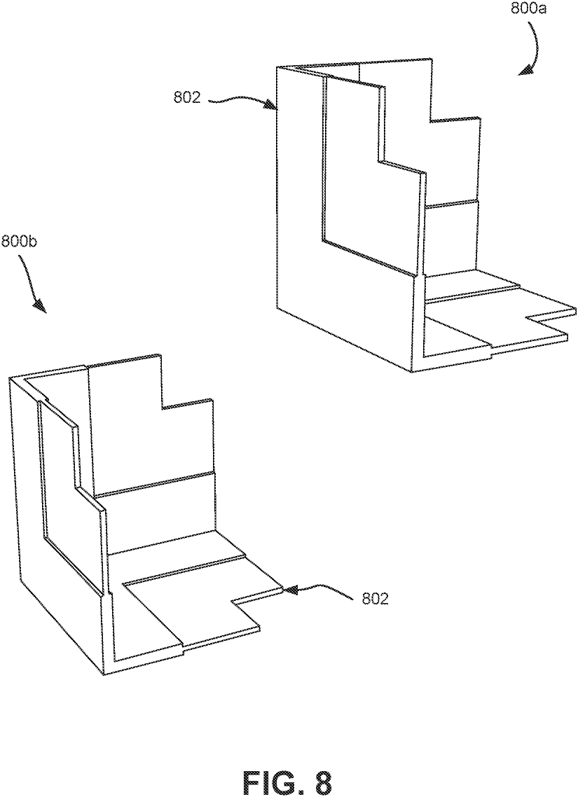

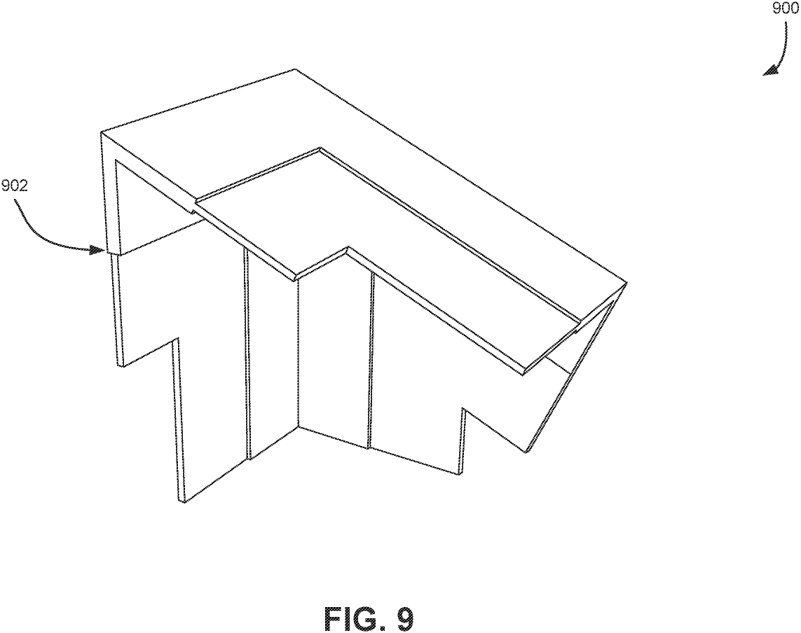

FIG. 9 illustrates a diagram 900 of an example of a non-tapered corner connecting element 902 for a 30-degree sloping connection between panels at a roof and two walls, for example. In some cases, this element could be used for both inner and outer skin connections as it is a non-tapered connecting-element. Any angle can be similarly accommodated.

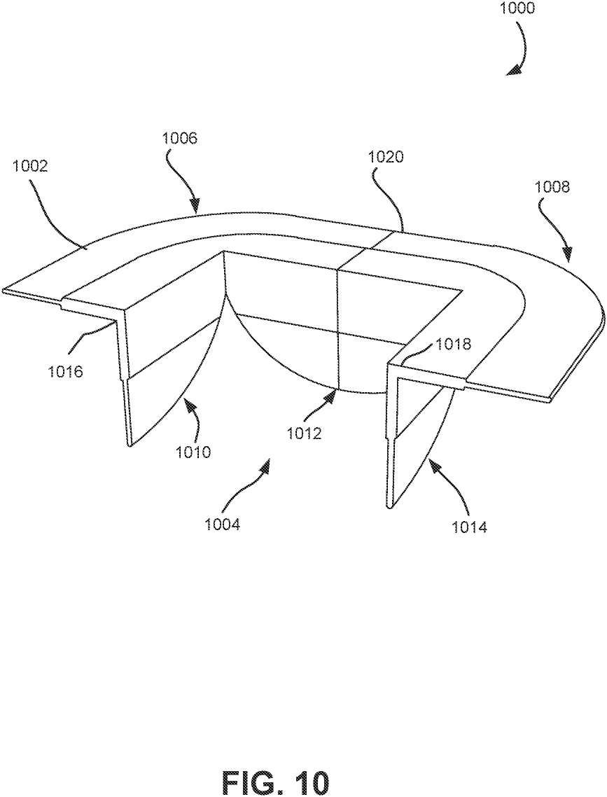

FIG. 10 illustrates a diagram 1000 an example of a simple end or linear connecting element 1002 for use at the end of a wall where the joint wraps from inner to outer skin, for example. In some cases, end connecting-element 1002 can be utilized where a wall edge ends, where it can be desirable for the connecting-element 1002 to wrap from inner to outer fiber-reinforced skin to transfer load between panels and to close off the joint against fire, water, air, insects, etc. End connecting element 1002 may form a slot or opening 1004 into which a wall or other panel can be placed (such as to cover the fins that define the slot 1004). As illustrated, the outer corners 1006, 1008, 1010, 1012, 1014 are rounded—these can be rounded at any radius to, for example, reduce the transfer of load into sharp corners that would focus the load and place more strain in the skin material of one or moth of the panels to be joined, among other reasons. In some cases, the connecting element 1002 may include two L-shaped or flanged sections 1016, 1018 and abridging element 1020. Sections 1016, 1018, and 10102 may define two extending edges, one set pointing downward in the example illustrated (forming a rectangular U shape), and the other extending horizontal (e.g., defining a planar flange for engaging with a similarly shaped recess in the skin or surface of another panel).

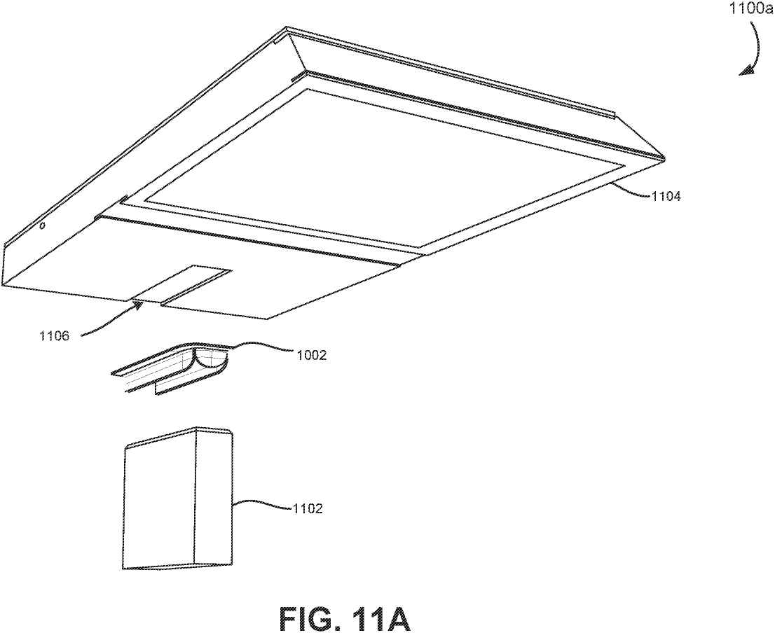

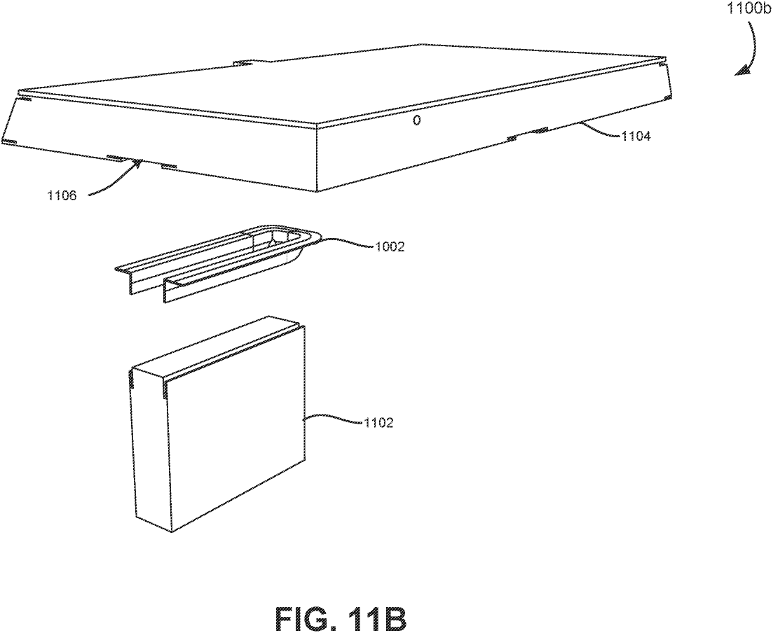

FIGS. 11A and 11B illustrate example views 1100a and 1100b of an example of the end connecting element 1002 described above in reference to FIG. 10 used to couple two panels, a vertical smaller panel 1102 and a larger horizontal panel 1104. In this example, panel 1104 may have a sub-dermal cavity 1106 into which the connecting-element 1102 can be inserted. In this example, the cavity 1106 may be reinforced with material to provide for a better more complete transfer of load between panel 1104 and 1102.

In some cases, a connecting element, such as element 1002, may form a building assembly or kit with at least two panels to be joined. Int his example a panelized building assembly, may include a linear joining element that includes a first L-shaped channel substantially parallel to and spaced a first width apart from a second L-shaped channel, and a bridging element connecting the first L-shaped channel to the second L-shaped channel. A first portion of the first L-shaped channel, a first portion of the second L-shaped channel, and the bridging element may define a planar flange. The L-shaped channels may also, in some cases referred to as flanged sections (both referencing structures such as or similar to 1016, 1018, and 1020).

The building assembly may also include a first composite planar panel that includes a core material sandwiched between two first skin elements and a first edge, with the first edge defining a first slot and a second slot within at least one first portion of reinforced material coupled to at least one of the first skin elements and between the first skin elements. The first slot and the second slot may be spaced the first width apart to accommodate receiving a second portion of the first L-shaped channel and a second portion of the second L-shaped channel. The building assembly may also include a second composite planar panel including a second core material sandwiched between two second skin elements, where a fist skin element of the two second skin elements at least partially defines a recess for receiving the planar flange of the linear joining element to secure and orient the first composite planar panel at an angle to the first skin element of the second composite planar panel.

In some cases, the bridging element may include a third L-shaped structure that in part defines the planar flange. In various examples, at least part of the first portion of the first L-shaped channel, the second portion of the first L-shaped channel, the first portion of the second L-shaped channel, the second portion of the second L-shaped channel, or the third L-shaped structure is rounded or angled at least one corner to transfer load more evenly across the first composite planar panel and the second composite planar panel, when joined via the joining element. In some cases, the recess in the second panel may include a T-shaped recess. In other cases, other shapes and topologies may be used to a similar effect to secure the joining element to a skin of a panel. In some instances, the second composite planar panel further includes a portion of reinforced material proximate to the recess, such as below the recess relative to the skin material, to reinforce the connection point between the panel and the joining element. In some cases, the recess spans substantially the length of the second composite planar panel. In some cases, at least one of the first portion of the first L-shaped channel, the second portion of the first L-shaped channel, the first portion of the second L-shaped channel, the second portion of the second L-shaped channel, or the third L-shaped structure is tapered.

In some examples, the building assembly may also include another panel that may be connected to one of the panels described above using a sub-dermal join and joining element, as described throughout this disclosure.

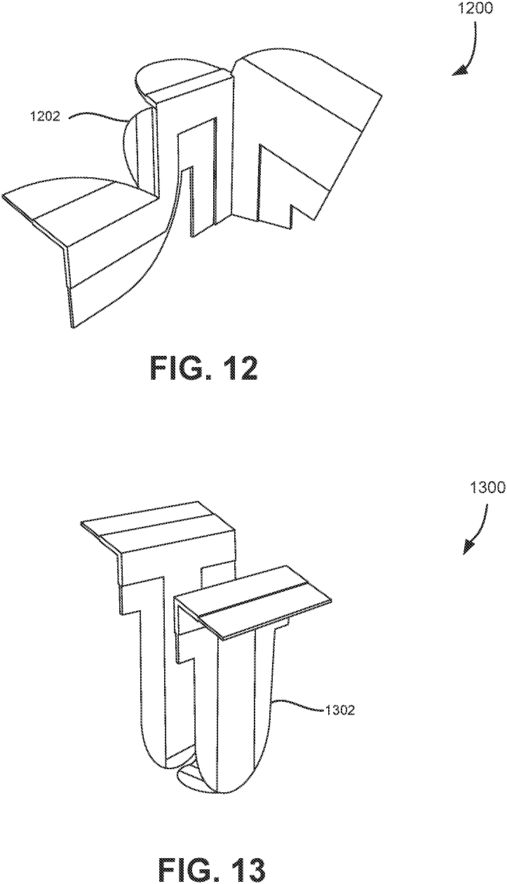

FIG. 12 illustrates a diagram 1200 of an example corner connecting element 1202. Corner connecting element 1202 may, in some cases be atypical or unique, which can be used join a roof and two wall panels. In some cases, corner connecting element 1202 may have a non-tapered profile that is the same at all three ends where it can be butt-jointed to a linear connecting-element of the same profile. In some cases, one or more corners of connecting element 1202 may be rounded, or take on various other shapes, to provide better load transfer between the panels connecting element is designed to connect.

FIG. 13 illustrates a diagram 1300 of an example linear connecting element 1302. Linear connecting element 1302 may be sued to connect wall panels joined to a roof panel at a window head. In some cases, one or more corners of connecting element 1302 may be rounded, or take on various other shapes, to provide better load transfer between the panels connecting element is designed to connect.

FIG. 14 illustrates a diagram 1400 of an implementation of the corner connecting element 1202 and the linear connecting element 1302 used to connect two panels 1402, 1404, such as where a roof and two wall panels may meet, with an additional corner piece 1406. In some cases, the non-tapered profile may be the same at all three ends were connecting element 1202 can be butt-jointed to a linear connecting-element 1302 of the same profile. The lower detail shows a connecting element between wall panels joined to a roof panel at a window head.

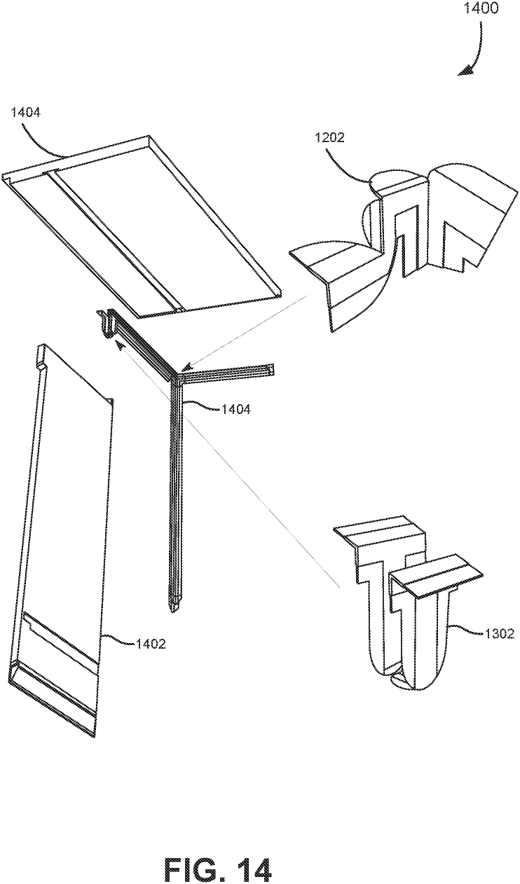

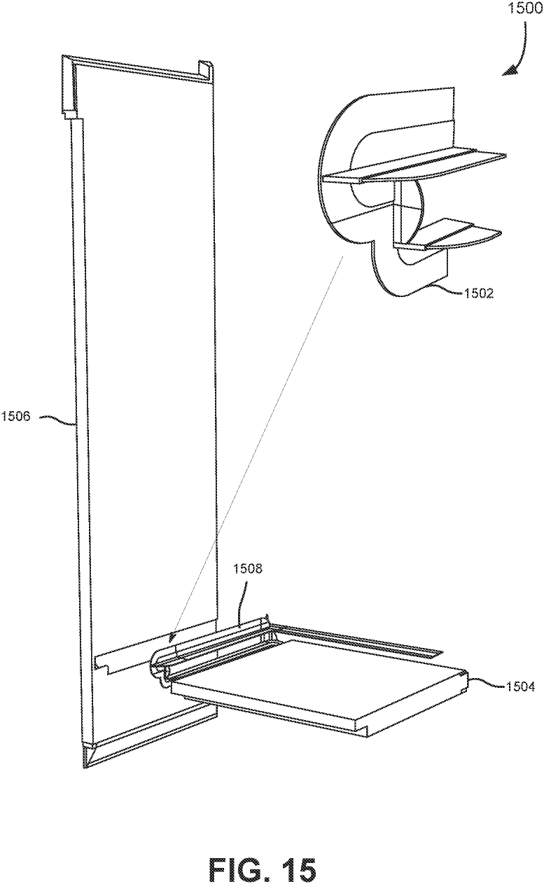

FIG. 15 illustrate a diagram 1500 of another example connecting element 1502 that joins a floor panel 1504 and two wall panels 1506 (only one is illustrated) where the edge of the floor is stepped to appear thinner. In some cases, connecting element 1502 may have a non-tapered profile that is the same at both ends where it can be butt-jointed to a linear connecting-element 1508 of the same profile.

In various embodiments, such as described above in reference to FIG. > 10-15, connecting-elements can run continuously along the edge of some or all panels that are connected to other panels, including some or all return edges around the ends of non-jointed panel sides (e.g., at wall ends, such as at a doorway). In some embodiments it can be desirable for connecting-elements to be as far as possible un-jointed along their length, cut to match the edge they are joining, so as to prevent water, air, insect or fire ingress at joints, or the like. In one example, very long pultrusions can be formed to permit full panel edges (e.g., of 60 ft or more) to be joined with a single linear connecting-element. In some embodiments, 60 ft can be a practical maximum for transportation by truck, as the largest US trucks are 55 ft, allowing 60 ft if elements hang over the end of a flat-bed trailer.

The shape of the connecting-elements in various embodiments can be that of a tapered plane, thicker in the middle where it carries all the load between the panels and diminishing in thickness as it overlaps more and more with the excavated cavity of the sub-dermal block that itself overlaps with the fiber-reinforced skin. In one example, the connecting element tapers towards the closest fiber reinforced skin (e.g., so that it transfers load into the sub-dermal block and into the fiber-reinforced skin in a differential and directed manner). In such an example, if the tapered connecting element comprises a fiber-reinforced pultrusion, then in various examples, the laminates can be progressively smaller (e.g., to attain the profile needed and have load-carrying capacity that is largest at its center and less at its extremities). In some embodiments this can minimize a load-concentration at the edges where the connectors end at the end of the excavated cavity, and in various examples this can mitigate a tendency for the sub-dermal blocks and the core to split at these locations, which they may otherwise be more prone to do in some examples. In one example, the connectors can be simple rectangular elements with non-tapered sides, as this can be suitable in some embodiments for low-load scenarios which may be typical in some small buildings such as single-family houses.

In various embodiments, the linear connecting-element and the corresponding corner connecting-elements can have different profiles to suit a given location and function, for instance in having a top-hat section where the brims of the hat extend into the cavities in the sub-dermal block and the top hat profile fills the exterior joint between trimmed sub-dermal block edges. The connecting-elements can in some embodiments be attached securely to both of their sub-dermal blocks such that they perform some or all necessary or desired building functions: for example, structural, water, air and weather-proofing, fire-retardancy, insect-resistance, UV resistance, wear and tear, and any other necessary or desired functions.

In one example, the attachment can be mechanical, such as a bolt, or screw linking through the joining element from one side of the sub-dermal cavity to the other, with some examples including gaskets or sealants attaining a necessary, desired or suitable water and/or air-tightness needed, desired or suitable in a contemporary building. In another example, the attachment can be by adhesive bonding, for example where the adhesive fills the gap in the excavated cavity around the connecting element. In some such examples, a bead of adhesive or prescribed volume may be introduced into the bottom of the excavated cavity in the sub-dermal block such that as the connecting element is pressed into it, so the bead can be displaced to fill the gap fully between the connecting element and the sub-dermal block.

Between the inner and the outer connecting elements in various embodiments there can be a gap left between the edge faces of the core panels, where the core panels may comprise of more than one material in some examples. This gap, from the core-side face of the inner to the core-side face of the outer connector, can in some embodiments be connected such that the adjacent cores can act in concert to carry shear and other forces. The connection can be mechanical, such as bolts or screws or any other suitable system or method (e.g., that effectively transfers load as in a shear-plate connection). In some embodiments it can (e.g., also or alternatively) be adhesively bonded by filling the gap with a (e.g., elastomeric) material that performs in similar manner to the core material itself, which in some embodiments can be slightly elastic in their low-density polymeric material properties, as for example in foamed materials such as EPS or PET, or the like. By being elastomeric in some embodiments, the adhesive may not break or tear the core material under load, which might occur in some embodiments if the adhesive is inflexible.

An adhesive core-to-core bond in various embodiments can transfer loads best by the gap between cores being fully filled, and in some examples (e.g., also) by bonding to the back faces of the two connecting-elements. In one example, such a core-to-core adhesive can comprise a peel-off adhesive tape that can be bonded to one core face with the second peel-off layer then removed as the second panel is pressed in place onto the adhesive strip. Another example can minimize adhesive volume by deploying it in a crisscross or other suitable pattern with trapped voids, or any other suitable pattern that attains necessary or desired load transfer per building code or other performance criteria, or for other suitable purpose.

The elastomeric adhesive can be well protected in the interior of the panel in various embodiments, for example shielded from radiant heat by the sub-dermal edge blocks and/or the connecting elements, but in some embodiments, it may still need to attain adequate fire performance such that it doesn’t liquify or gasify under radiant heat load, as this may compromise the structural integrity of the panel-to-panel assembly. In various embodiments, any suitable elastomeric adhesive can be used. In some embodiments, it can be desirable for adhesives and/or resins to be non-toxic and/or suitable for building use per building codes and other relevant technical criteria or for other suitable purposes. This can be important in some examples to avoid off-gassing and/or unpleasant odors in the building.

### Alternative/Additional Description and Embodiments

In some cases, various embodiments of the sub-dermal jointing for composite panel buildings can be described as follows. In various embodiments, a desirable performative aspect of a fiber-reinforced structural composite panelized building can be the joints between the panels, because in some examples the panels themselves can be engineered to meet thermal, structural, weatherproofing, fire retardancy and any other functional requirements mandated by building codes or other technical performance criteria or for other suitable purposes. The joints between such large code-compliant composite building elements can be where there is a gap between adjacent panels, that gap being vulnerable in various examples to some or all these same functional requirements, and in some examples where air and water leaks occur, where thermal bridging occurs, where fire takes hold most effectively, and where structural performance may be most vulnerable to compromised load-carrying capacity. This can in some embodiments be true in a class of materials where load can be carried in pairings of thin fiber-reinforced skins that may generally favor seamless continuity of fiber-reinforcement to perform as a monocoque structure.

The vulnerability of joints can in some embodiments be countered by establishing a ubiquitous double-layer of continuous connecting-elements, one extending sub-dermally beneath the outer fiber-reinforced panel skin, the other extending sub-dermally beneath the inner fiber-reinforced skin. These can run along some or every panel-to-panel edge, establishing a ubiquitous double skeleton in some examples, with elastomeric adhesive linking the mid-point of the inner connecting-elements and the outer connecting-elements: so, in various embodiments, two solid structural elements and one elastomeric connector filling in-between some or every panel-to-panel gap.

The structural connecting-elements may be jointless along some or all linear edges except in some examples at corners where two or more edges meet (e.g., where they are either adhesively butt-jointed to the next linear connecting-element or adhesively butt-jointed to a small corner connecting-element). The result in various embodiments can be a polygonal skeleton around some or every panel that forms for example a continuous, impermeable double-layer of structural connecting-elements. Conceptually, in various examples this skeleton describes the volume of the building, with the composite structural panels then infilling between the vital joints.

The connecting-elements that can comprise the skeleton of joints are structural connectors allowing load-transfer from skin-to-skin in adjacent panels. They can be structurally attached to the panels in some examples by being inserted into cavities in sub-dermal blocks at some or every panel edge. The sub-dermal blocks that run along some or every panel edge can be bonded to the fiber-reinforced structural skins of the composite panels on some or the totality of the faces that abut the skins and can be continuously bonded to some or all surfaces of the core materials on their inner faces in accordance with various embodiments.

Such a continuous skeleton of connecting-elements, having very few adhesively-sealed butt-joints in various embodiments, attain air- and water-impermeability, and can also defend the gap(s) between panels from fire and insects, or the like. The majority or at least a portion of their surface can be embedded in cavities in the sub-dermal blocks that can run around some or all panel edges, with only a narrow mid-section exposed to the external environment or the internal space in various embodiments. So, in some examples, there can be only a narrow strip of the connecting element that provides a defense against external threat, minimizing risk of it being compromised in some examples. In a fire event, in some embodiments the fiber-reinforced skins and/or the sub-dermal blocks can defend the connecting elements, and in various example allowing greater retardancy to degradation of the connecting-elements than the rest of the panelized building envelope. In other words, in various embodiments the structural skeleton, establishing quasi-monocoque structural performance, can be the best protected aspect of the building, as it should be in various embodiments: for example, the structural joints can be designed to be the last thing to fail in a fire.

The connecting-elements, being slightly closer together than the fiber-reinforced skins of the composite structural panels in some embodiments, may be stronger to attain the same stiffness as the panel skins in various example, as the separation between them may be less. For this or other suitable reason, the connecting-elements can have better structural capability than the fiber-reinforced skins. In one example, more fiber or a higher modulus fiber can be sued for the connecting elements if they are composite, such as pultrusions in some examples. This can mean that in various embodiments they will survive longer in a fire event than the panels themselves, so fulfilling the need or a desire for the base structural connectors to maintain integrity longer than the infill panels, avoiding in various examples catastrophic collapse by joint failure. The net result of establishing a ubiquitous jointing logic in various embodiments can be that anywhere in a building, or at least in some portion in a building, some or all the joints can attain the same or similar performance, defending against water, air, fire, insect penetration, and the like and attaining a robust and resilient structural connectivity between two or more adjacent panels.

By linking skin-to-skin structurally via sub-dermal structural connecting-elements, in various embodiments the entire assembly or a portion of the assembly can become quasi-monocoque, allowing a plurality of discrete panels to be brought together to offer a coherent structural capability. The fiber-reinforced thin-skins of the composite panels of various embodiments can become the primary load-carrying elements, and in some examples with load transferred via the sub-dermal blocks at the panel edges to connecting-elements that link to one or more adjacent skin(s). The load path of some embodiments diverts only slightly from fiber-reinforced skin into sub-dermal structural connecting-element and back out to the adjacent fiber-reinforced skins, allowing in various examples the assembly to perform as the primary structure of the building.

Beams and columns in some embodiments may be joined to such a monocoque panelized assembly to offer local structural capacity, but in various examples the panel-to-panel sub-dermal jointing can allow for thin-skin composite structural panels to perform structurally per building codes or other performance criteria or for other suitable purpose.

### Example Geometry of Sub-Dermal Joints

In various embodiments, defining a ubiquitous geometry for the sub-dermal jointing can offer an effective way to establish a base logic in what can be a highly versatile building technology that in some examples permits any suitable arrangement of any suitable polygonal planer composite panels of any suitable plurality to be co-joined to form (e.g., code-compliant) building assemblies. It should be clear that the geometry of the sub-dermal jointing can vary around a building according to engineering or aesthetic needs or for other suitable purposes. However, in one example, the geometric logic is maintained throughout the entire building, or a substantial portion of the building, as a controlling logic as this can offer a simplicity and standardization of design manufacture that can aid speed and/or economy of the building.

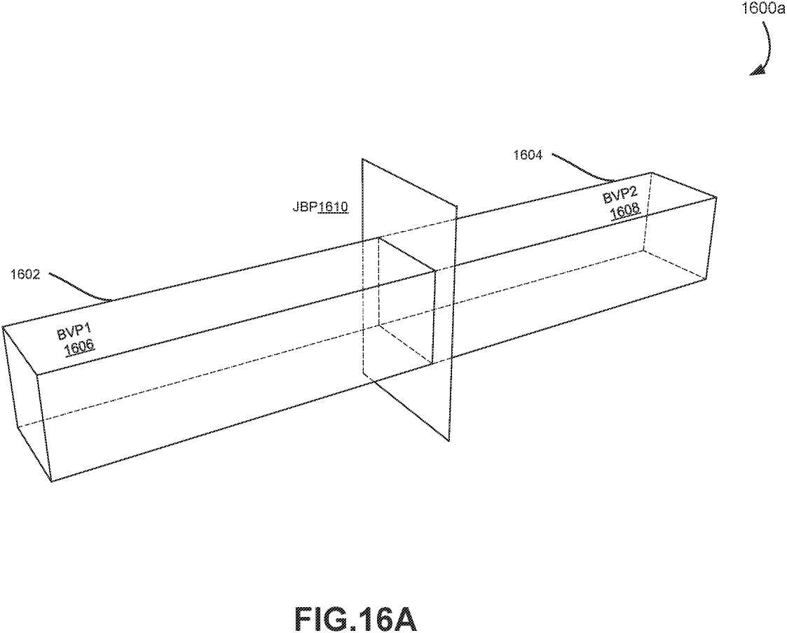

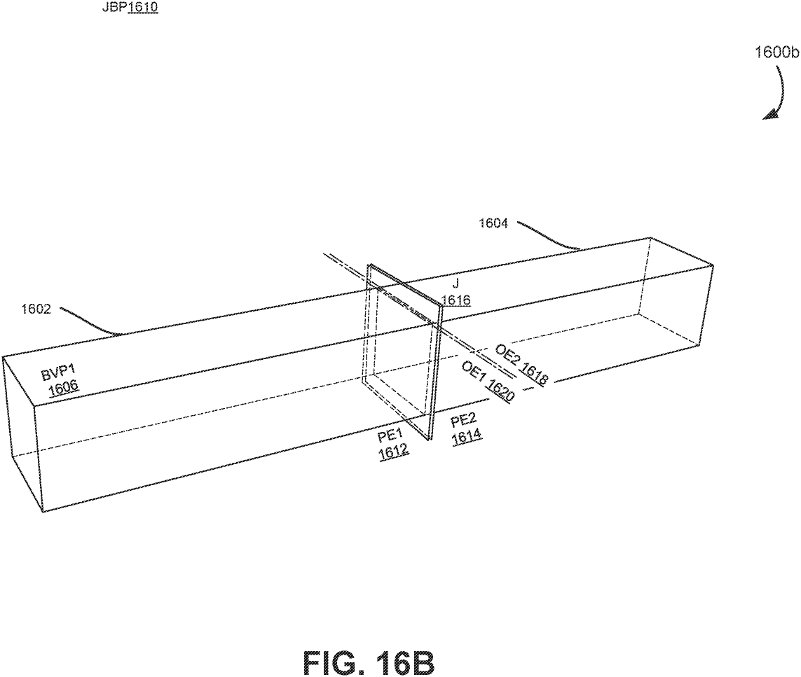

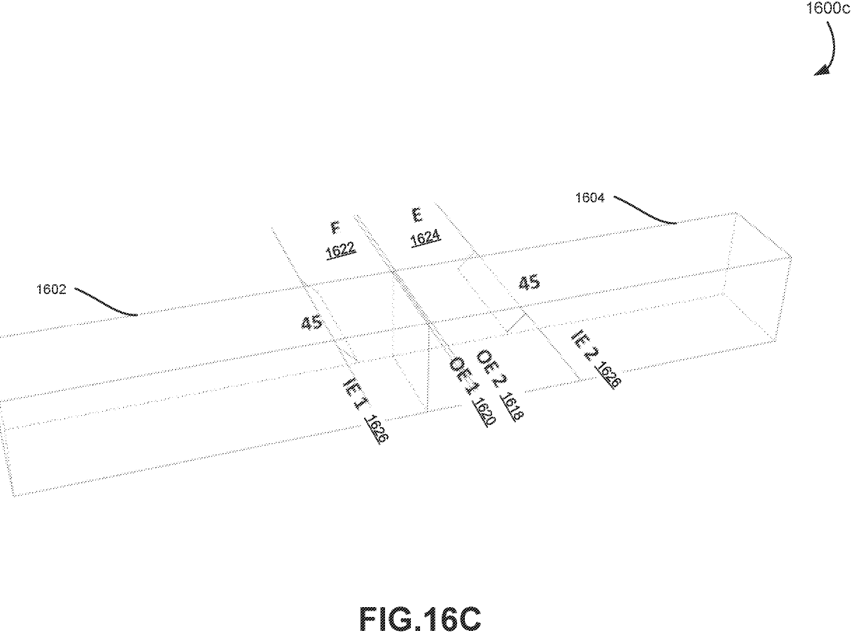

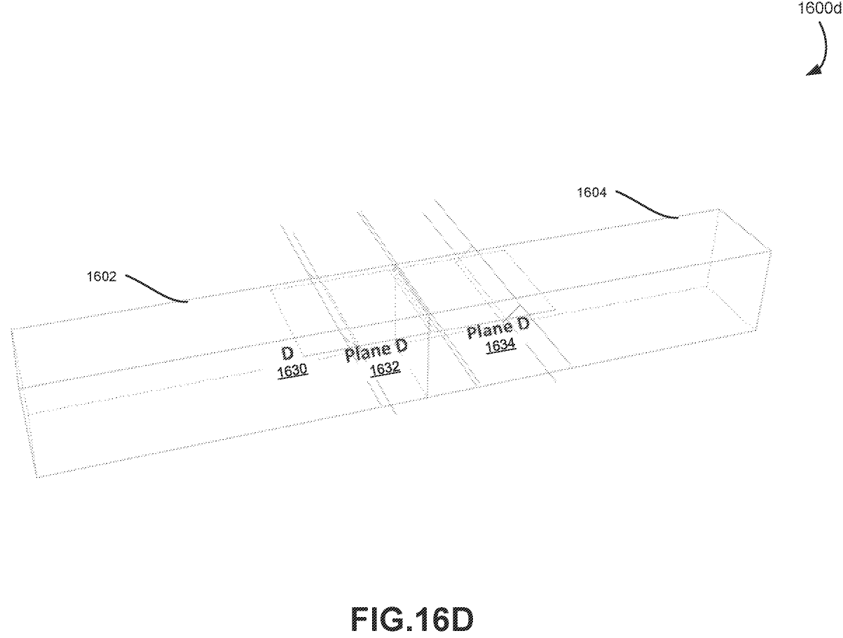

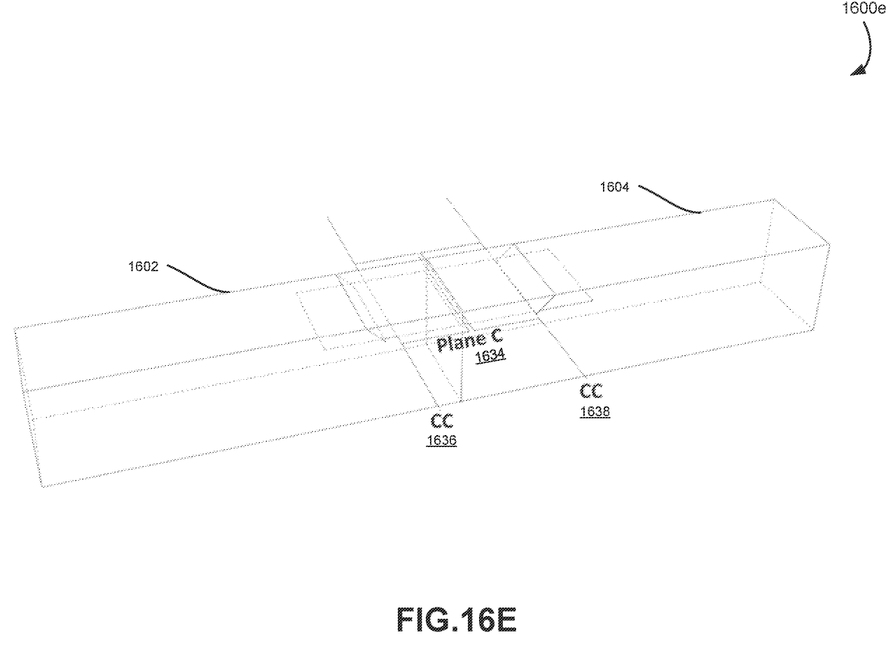

In the example where a consistent geometric logic is established, the base parameters can be as follows in various embodiments. FIGS. 16A-16E illustrate example diagrams 1600a-1600e of the geometry of an example joint.

As illustrated in diagram 1600a, for a skin-core-skin composite panel where the fiber-reinforced skins are parallel, a Base Polygonal Volume (BPV) can be established in some examples that fills between the inner faces of the two structural skins, this volume can be extended in various embodiments to the point at which it intersects with a similar polygonal volume from one or more adjacent panels. As illustrated beams 1692 and 1604 may respectively have BPV1 1606 which abuts BPV2 1608 (and so on). The plane of intersection of adjacent BPVs, the Joint Bisector Plane (JBP) 1610, can be defined where the volumes intersect, which can be the bisector of the angle between the BPVs 1606, 1608, the plane extending from the inside of inner skin to one skin to the inside of the other skin. This plane can be the centerline of an eventual joint between panels.

As illustrated in diagram 1600b, Planes PE (Panel Edge), such as PE1 1612 and PE2 1614, can be offset on both sides of the JBD 1610 by a distance ½J where J 1616 can be the full Joint Width. Where the BPV intersects the PE planes can be what defines the faces of the core of the panels at the joint. In one example, the joint width J 1616 can be 10 mm, so each PE 1612, 1614 is 5 mm offset each side of JBP 1610. In some cases, the Outer Edge OE of the polygonal panels can be the line formed by the intersection of the BPV and PE, which can be in some examples a continuous polygonal line describing the outer edge of the panels, such as illustrated as OE1 1618, OE2 1620.

As illustrated in diagram 1600c, the outer edge OE, 1618, 1620, can be offset a distance E 1622, 1624 on the planar surface of the BPV away from the JBP 1610. This can define a polygonal line Inner Edge (IE) 1626, 1628 that can be the width of the sub-dermal Edge Block that can be formed under the inner face of the fiber-reinforced skin. Because the panel can be polygonal in various examples, this offset IE 1626, 1628 can be a polygonal line offset equally from some or all OEs 1618, 1620. In one example E is 70 mm. In some cases, the surface between OE and IE can be the outer face of sub-dermal block. A plane can be extended from the IE 1626, 1628 into the depth of the BPV at 45 degrees towards the JBP, defining the tapered inner face of the sub-dermal block.

As illustrated in diagram 1600d, a plane offset inwards from the outer skin faces of the BPV can be offset a distance D 1630 that can be the depth of the sub-dermal edge. This plane D 1632, 1634 can be cut by the 45-degree plane from the IE and by the PE planes, this polygonal band forming the inner face of the sub-dermal block. In one example D = 25 mm.

As illustrated in diagram 1600e, a plane C 1636 can be offset from the skin surfaces of the BPV towards the center of the BPV by a distance C (Cavity). Where this plane intersects the JBP a line C can be created. In one example, C = 12.5 mm, this being at the mid-point of D = 25 mm. The polygonal line CC 1636, 1638 can be offset on both sides from the JBP on the plane C, establishing the depth of a cavity in the sub-dermal block on the centerline of the cavity. In one example, the offset distance from C to CC (the Cavity Depth) can be 50 mm. In various embodiments, CC should not cross the 45-degree plane from IE, as this would mean the cavity is deeper than the sub-dermal block that encases it. The cavity width CW can be tapered in various embodiments and can be defined by a tool such as a disc that excavates it from the sub-dermal block to the depth CC.

The outermost edge of the face of the sub-dermal block that lies on the PE can define a plane perpendicular to the skin face of the BPV. This plane can be offset outwards by a distance T (Tolerance) outward from the panel, establishing in various embodiments a polygonal line outside the OE that provides a tolerance T of extra material for the sub-dermal block to allow for, in some embodiments, manufacturing tolerances such as mis-placement on the cutting table.

In various embodiments, such a geometric logic can apply to some or all jointed edges of some or all fiber-reinforced panels. In one example, the offset planes and lines can have consistent dimensions throughout a given project or portion thereof, which can have great practical advantage in offering a standardization in a non-standard panelized building system or for other suitable purposes. In other words, the joint parameters can be consistent, but the panel geometry can allow for variation of panel geometry and building form.

In various embodiments, these same geometric rules may apply no matter what the angle is between panels and no matter what polygonal shape the panels may have (or at least within various suitable ranges or types of panels). Returning to FIGS. 1A-1D, the described jointing logic can be applied to a 90-degree corner with a sloped roof at 30 degrees, but where the depth and length of the sub-dermal blocks, as well as the length of the cavity and connecting-element within the sub-dermal block, can be (e.g., absolutely) consistent throughout the different panels or a set of the panels. Some or every joint in this example 9-panel building corner can adopt the same geometric logic and parameters, with some or every connecting element having the same sub-dermal distance below the fiber-reinforced skin, penetrating into a cavity in a sub-dermal block that can be a prescribed distance from the Joint Bisector Plane, in various examples regardless of whether panels are 180, 90 or any angle. This is one example of consistent jointing geometric logics being adopted in accordance with some embodiments.

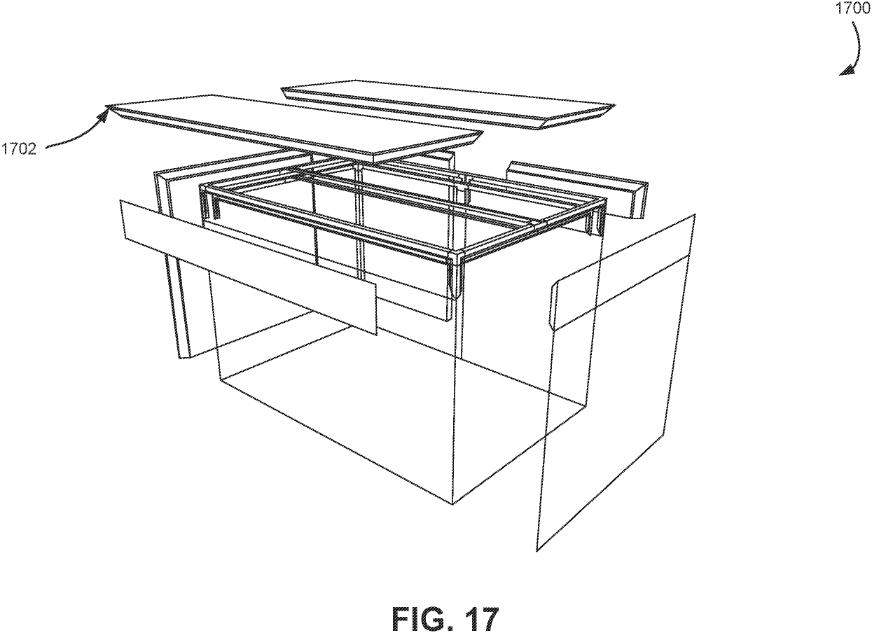

FIG. 17 illustrates an example diagram 1700 of 7-panel assembly 1702 to form a corner that can meet the National Fire Prevention Association criteria for testing as a building assembly. In some examples, a sub-dermal jointing logic of a double skeleton of connecting-elements can be applied to the 7-panel assembly 1702, which can undergo a NFPA 286 Room Corner Fire Test, which is a stringent test of fire retardancy in a multi-panel assembly. Here, fire can be defended against by the double skeleton of connecting-elements and the sub-dermal edges, both working together to create a thermal shadow to the vital structural connection, shielded from radiant heat by the material of the sub-dermal edge block.

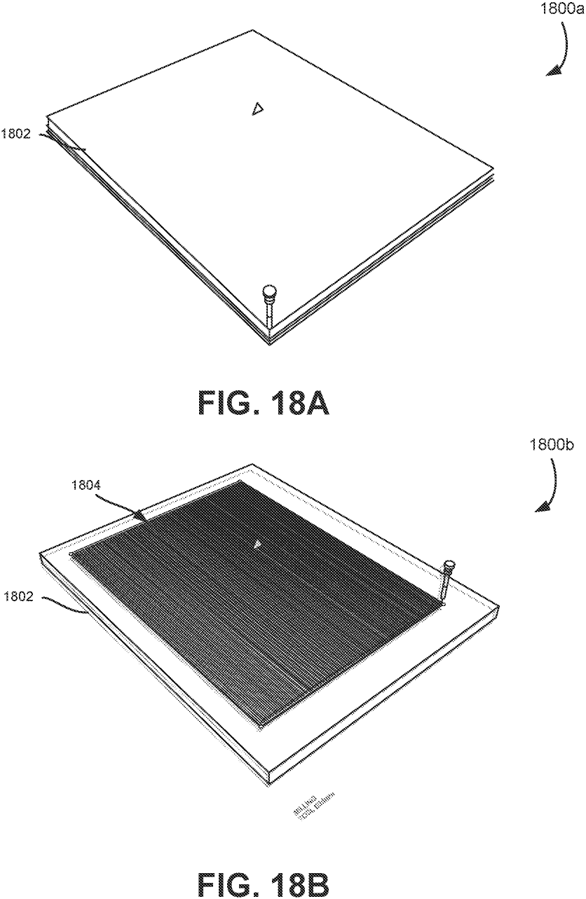

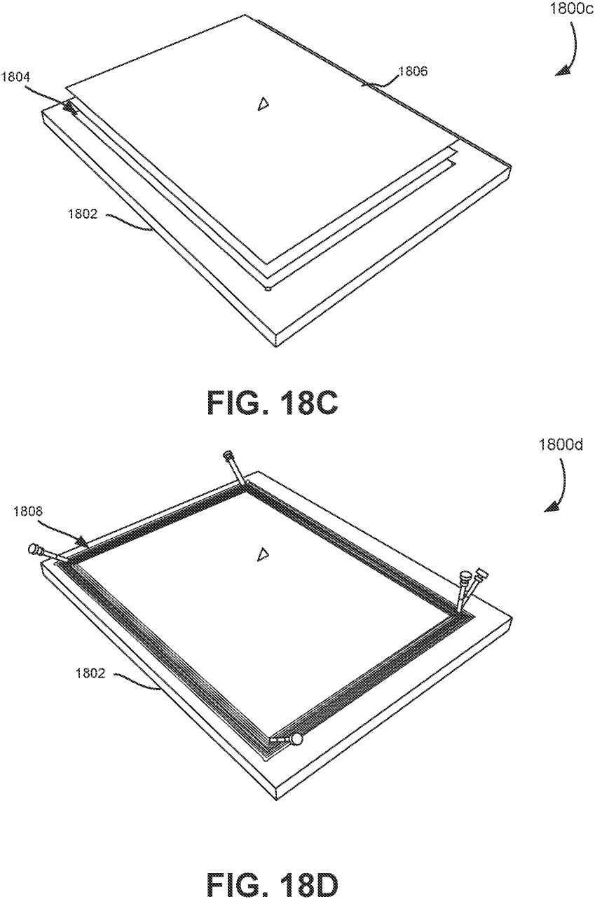

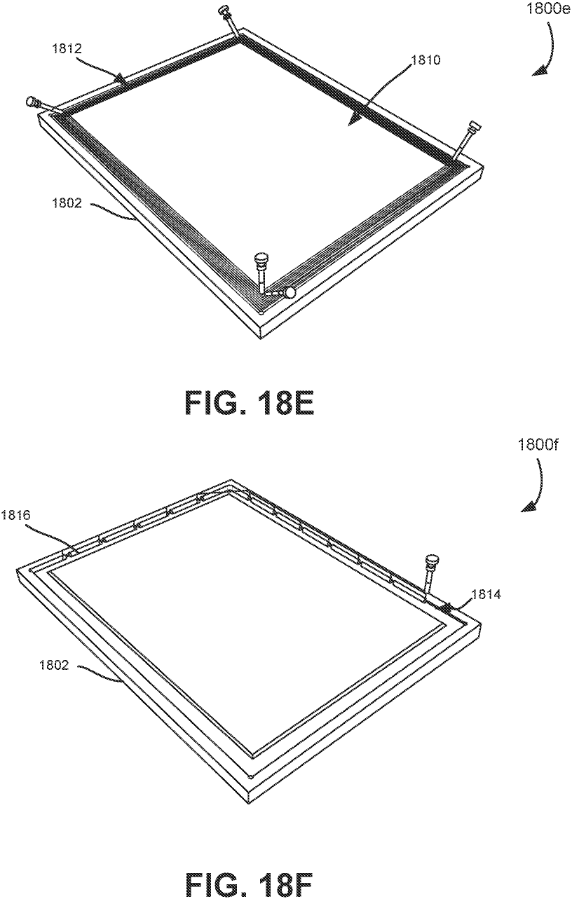

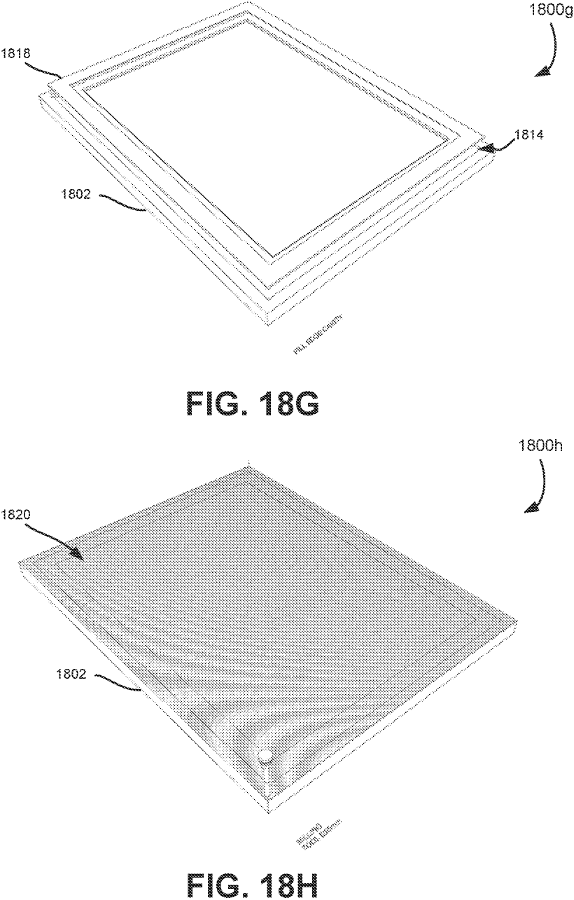

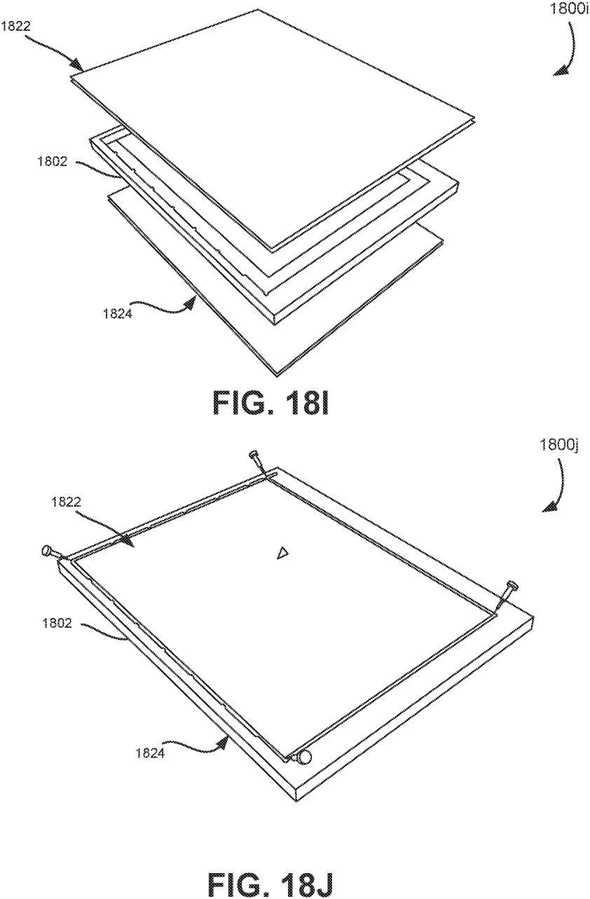

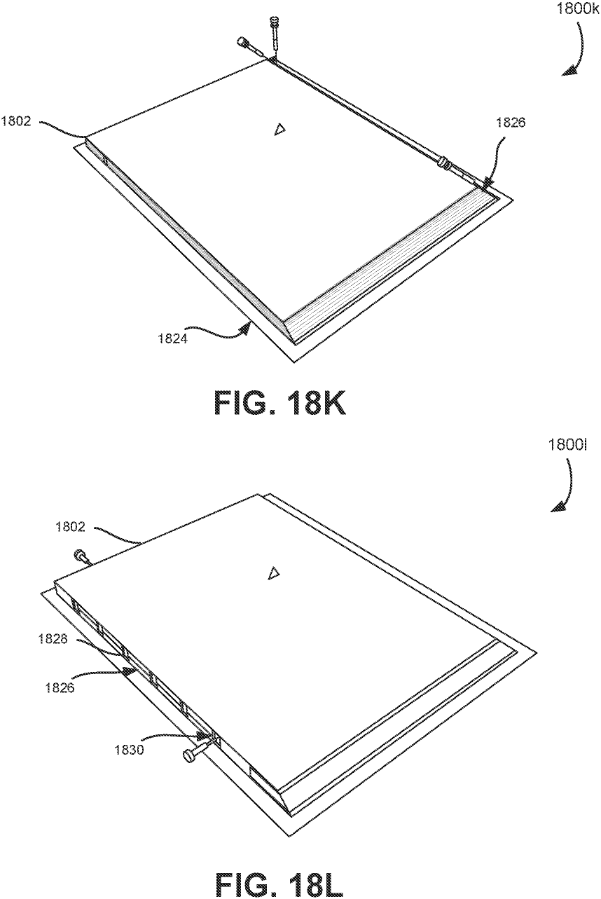

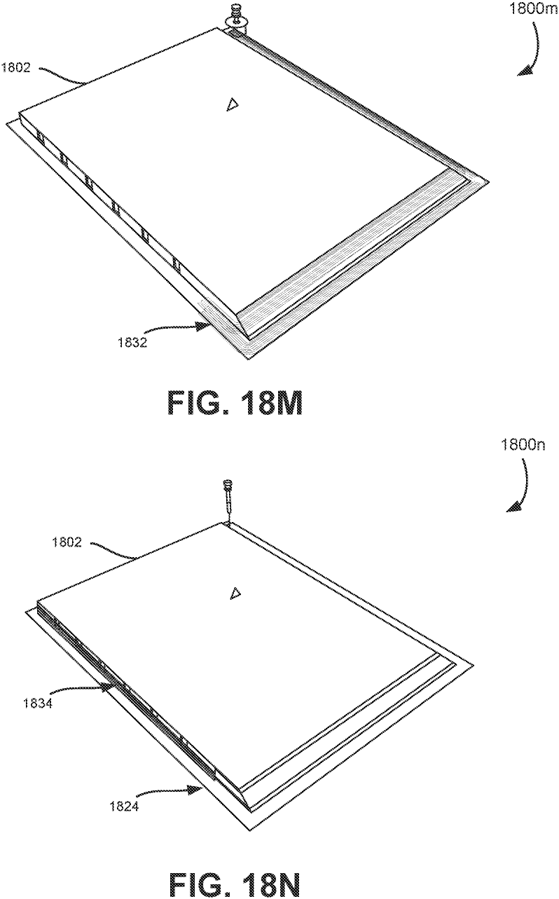

FIGS. 18A-18O illustrate example stages 1800a-1800O in an example process to manufacture a wall panel, in accordance with at least one embodiment. As illustrated, one of the panels is shown below going through a step-by-step automated manufacture to attain composite panels with sub-dermal edges cavitated for connecting elements to be inserted into that can provide a double skeleton to perform structural, thermal, acoustical, weather-retardant, waterproofing, insect-resistant functionality at the gaps between panels.

FIG. 18A illustrates an example view 1800a of a panel 1802 of insulating core material that can be trimmed to ensure dimensional accuracy and clean edges.

FIG. 18B illustrates an example view 1800b of core 1802 where a cavity 1804 can be milled for a sub-dermal lining such as cork or C-Foam to offer acoustical, fire or other performance.

FIG. 18C illustrates an example view 1800c of a sub-dermal lining 1806 being added to and bonded to into cavity 1804 of core 1802.

FIG. 18D illustrates an example view 1800d of a second cavity 1808 being excavated from the multi-material core with a 45-degree inner edge in this example.

FIG. 18E illustrates an example view 1800e of the milling process illustrated and described in reference to FIG. 18D being repeated on the other side 1810 of panel 1802 to excavate another cavity 1812.

FIG. 18F illustrates an example view 1800f of cavities 1814 being created with bridging elements 1816 to support solid, liquid or semi-liquid filler materials, such as where there are wall edges that will be unjointed.

FIG. 18G illustrates an example view 1800g of a dense solid, liquid or semi-liquid filler material 1818 bonded into the cavity 1814 to create an integrated multi-material panel.

FIG. 18H illustrates an example view 1800h the core and filler can be sanded or fly-milled flat 1820 on both sides ready for application of a fiber-reinforced skins.

FIG. 18I illustrates an example view 1800i of fiber-reinforced skins 1822 and 1824 being uniformly bonded to both sides of the multi-material core 1802 by adhesive or resin.

FIG. 18J illustrates an example view 1800j of the fiber-reinforced skins 1822, 1824 being severed by a diamond-encrusted endmill, router or saw to cleanly sever the fiber and filler.

FIG. 18K illustrates an example view 1800k of panel 1802, where the cores 1826 can be severed just outside the clean-cut fiber/edge, leaving the lower skin 1824 uncut.

FIG. 18L illustrates an example view 18001 of panel 1802, where the bridges 1828 of core 1826 can be excavated and filler material 1830 applied to fill in cavities, finished to match edge material.

FIG. 18M illustrates an example view 1800m of panel 1802 where the severed sub-dermal edge blocks can be cavitated (as represented by tool lines 1832) accurately by a disc or endmill where panels will join to adjacent panels. In some cases, connecting elements can be bonded in these cavities.

FIG. 18N illustrates an example view 1800n of panel 1802 where the lower skin 1824 and filled edges 1834 can be cleanly cut, milled, routed or burred to attain a high-quality skin and edge.

FIG. 18O illustrates an example view 1800o of the finished fabricated fiber-reinforced composite structural panel 1802, such as including thin veneers or paints, in one example with a fire-retardant intumescent paint. The cavitated edges can be ready for sub-dermal connecting elements to be bonded into them. This example step-by-step fabrication protocol can offer a method in some embodiments to create any suitable polygonal panel with sub-dermal jointing that can in various embodiments allow for all-composite buildings to be assembled quickly and easily to attain highly energy-efficient buildings that also have low embodied energy. The sub-dermal jointing can attain building code compliance without any additional elements other than those integrally bonded into the composite panels.

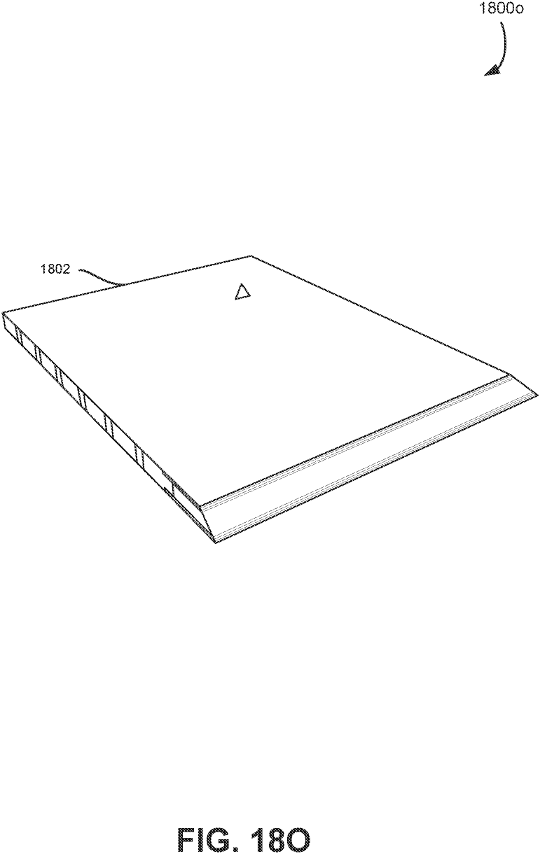

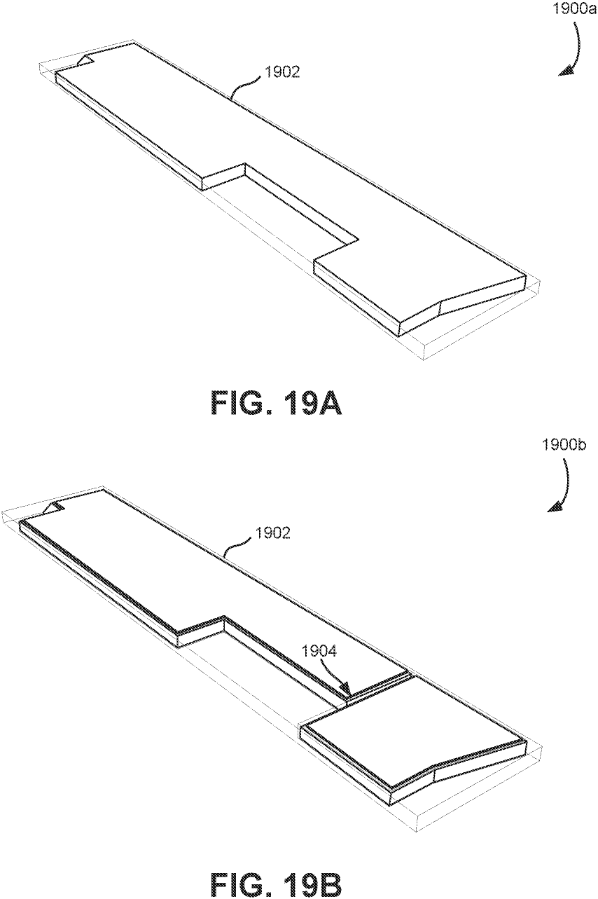

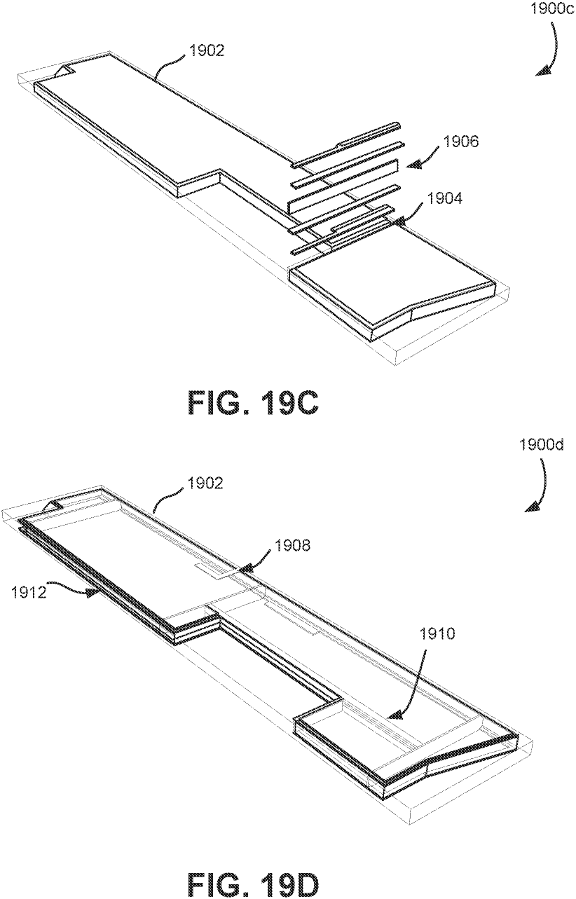

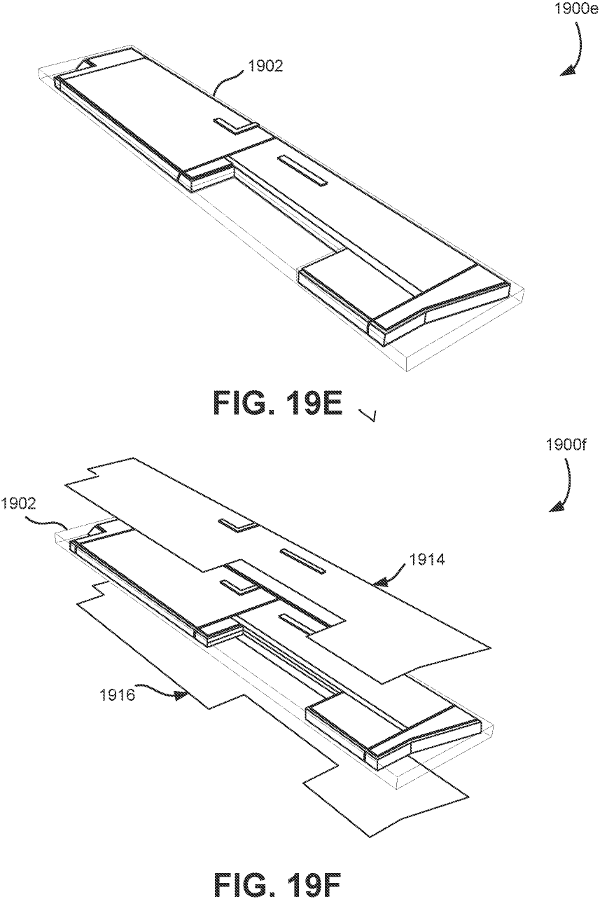

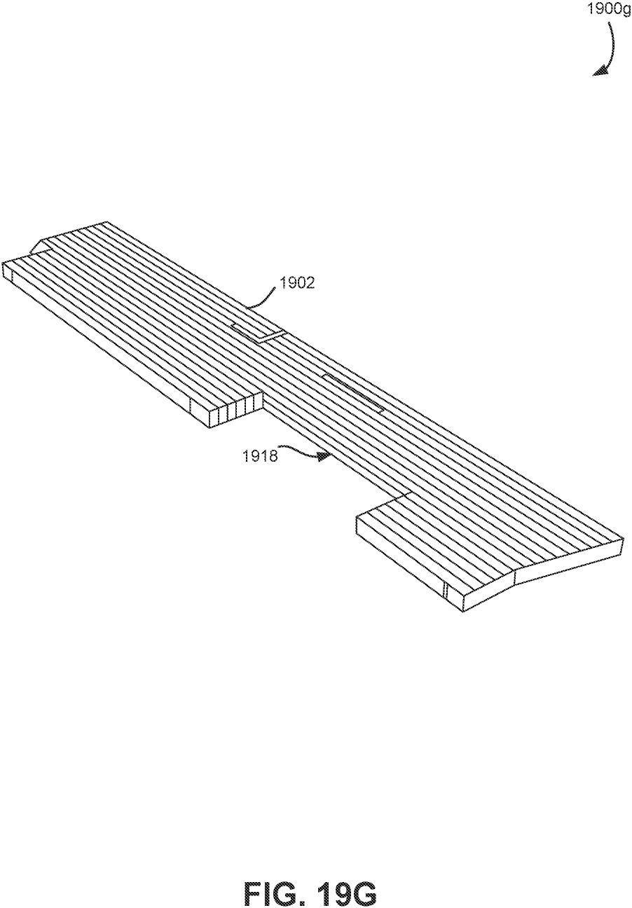

FIGS. 19A-19G illustrate example stages in an example process to manufacture a complex floor panel.

FIG. 19A illustrates an example view 1900a of a rough outline of an example polygonal floor panel 1902 cut from a base rectangular mother-board.

FIG. 19B illustrates an example view 1900b of panel 1902 with the core cavitated 1904 by cutting, milling or routing ready for sub-dermal inserts to augment performance as needed or desired.

FIG. 19C illustrates an example view 1900c of panel 1902 where the milled cavities 1904 in the core can be filled with materials 1906 as needed or desired that can offer structural reinforcement, density for milling details, resiliency for fixings, etc. Materials 1906 can be any suitable materials compatible with and bonded to the core and fiber-reinforced skins, and they can take any suitable form that can cavitated and filled.

FIG. 19D illustrates an example x-ray view 1900d of panel 1902 showing that sub-dermal cavitation and inserts 1908, 1910 can be added as needed or desired to augment the performance of the skin-core-skin fiber-reinforced composite structural panel 1902, with structural skin-to-skin reinforcement as well as the sub-dermal edge 1912 that can enable sub-dermal structural jointing of one to another.

FIG. 19E illustrates an example view 1900e of the integral sub-dermal core panel 1902 with inserts ready for sub-dermal edge filler for structural jointing.

FIG. 19F illustrates an example view 1900f of panel 1902 with fiber-reinforced skins 1914, 1916 bonded on both faces to attain a structural composite panel with highly integrated sub-dermal inserts.

FIG. 19G illustrates an example view 1900g of finishes 1918 that can be applied to the panel 1902 as needed or desired (e.g., example wood veneer planks shown below), then cut, trimmed or routed to attain clean edges and to expose the sub-dermal filler material.

As illustrated in views 1900a-1900g, this floor panel shows a large structural element (e.g., 40 ft × 8 ft × 10″) that can rely on cavitated sub-dermal infill of functional materials just as needed or desired locally to fulfill functional requirements in that specific location according to building codes or other technical criteria or for other suitable purpose. Attaining variable-form, poly-functional building elements, with jointing integrated into the edges regardless of geometry, can offer great benefit in some embodiment in offering a simple, rapid, low-labor methods for assembling high quality and high-performance buildings.

### Example Geometric Logic

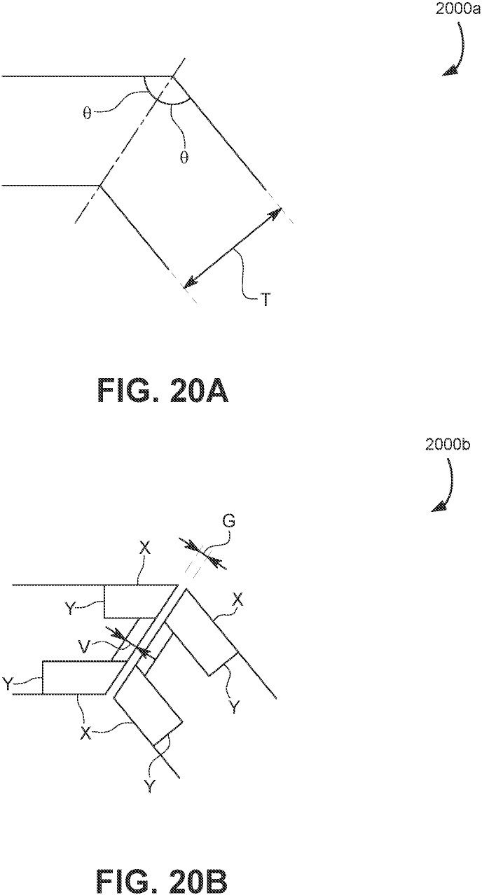

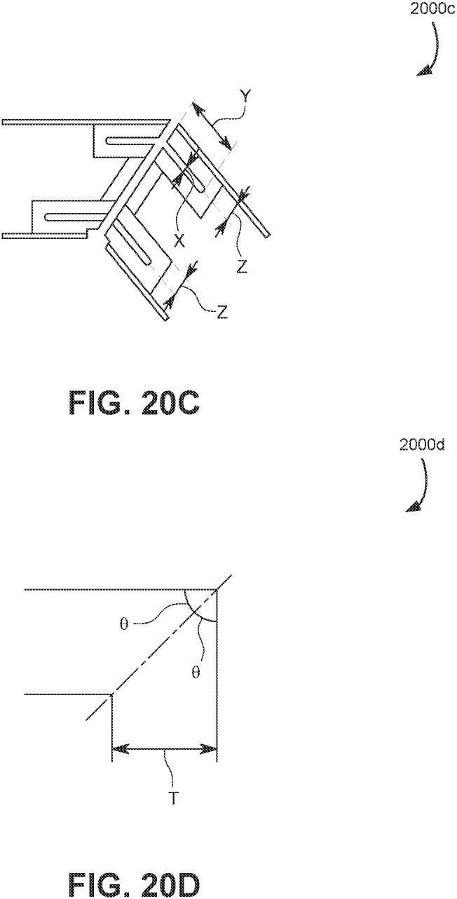

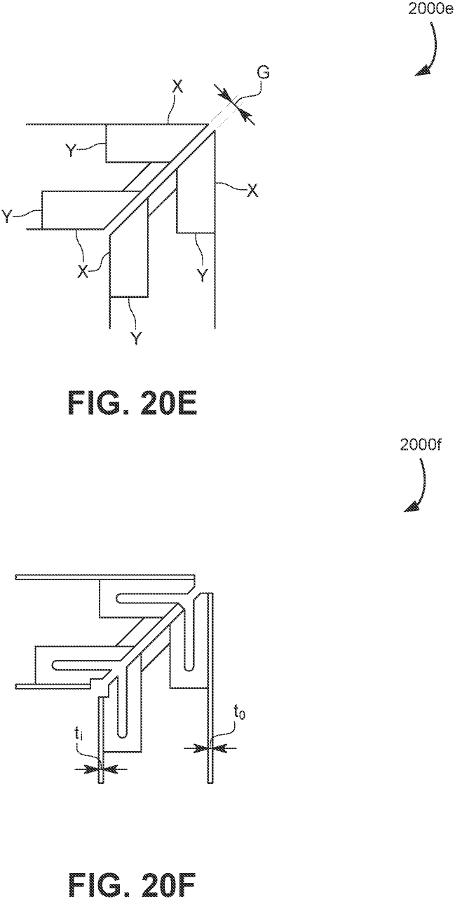

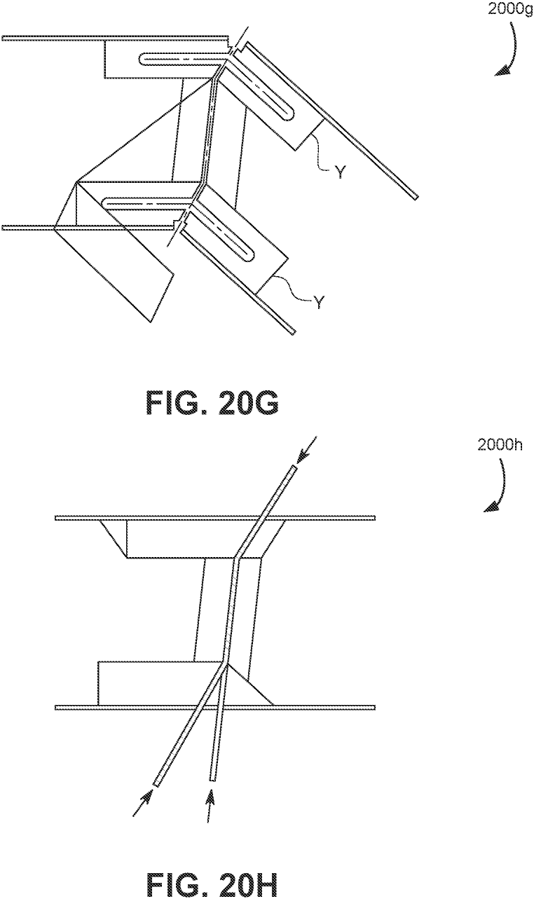

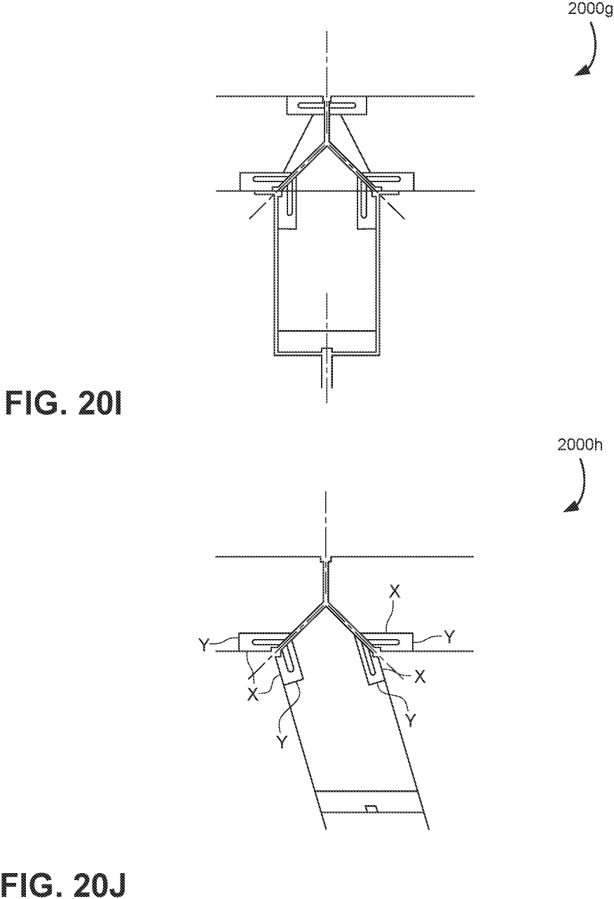

FIGS. 20A-20J illustrate example topologies 2000a-2000j for various joints. In some cases, the basic geometric schema of jointing, as illustrated in diagrams 2000a-2000j, can take on any angle in a topologically identical or similar way, in various embodiments. Diagrams 2000g-2000h show an orthogonal and non-orthogonal T-junction showing topological consistency.

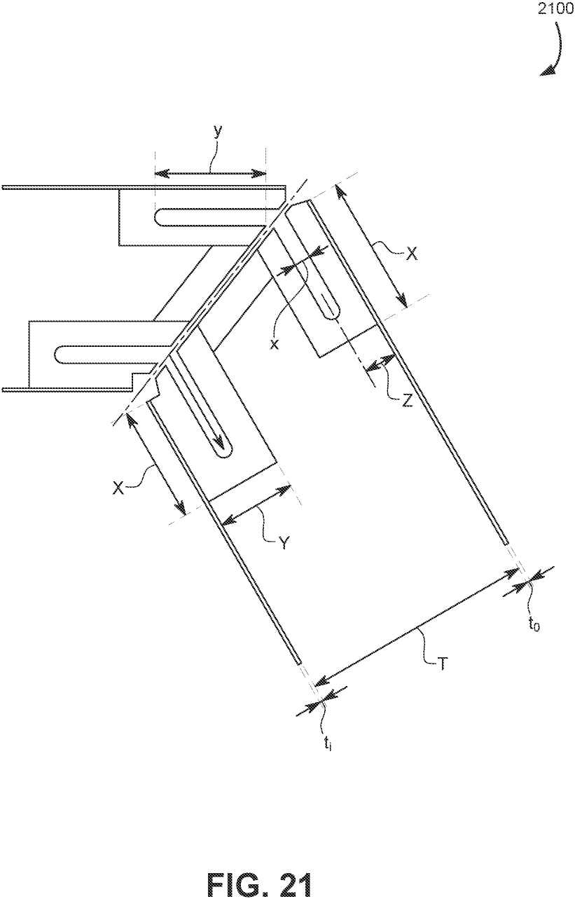

FIG. 21 illustrate an example topology 2100 for a joint that can accommodate various angles.

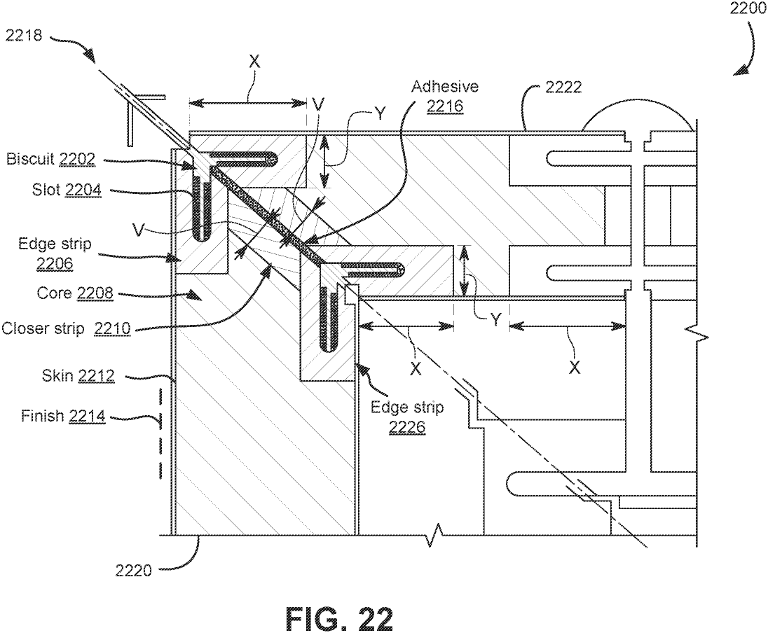

FIG. 22 illustrate an example topology 2100 for another joint 2218, showing relative position of biscuit 2202, fitting into slot 2204, where the slot is defined by or within edge strip (e.g., block of sub-dermal material, such as a reinforced material). Joint 2218 also shows that the edge strip 2206 is located in a bigger core 2208 contained by skin 2212, and optionally by one or more finishes 2214 on skin 2212. Joint 2218 also illustrates adhesive in between the two panels 2220, 2222, and a strip of additional material 2210 spanning the edge of each panel 2220, 2222 to add support between edge stripes 2206, 2226. As illustrated, the details of the outer biscuit j oint may be replicated in whole or in part for the inner j oint or edge of panels 2220 and 2222.

### Example of Manufacturing of a Sub-Dermal Edge With Internal Connecting Elements

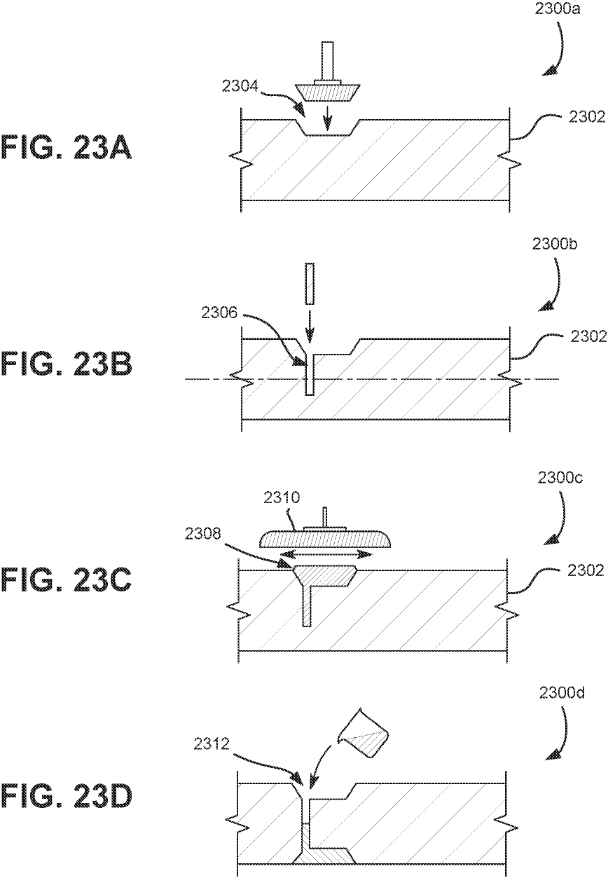

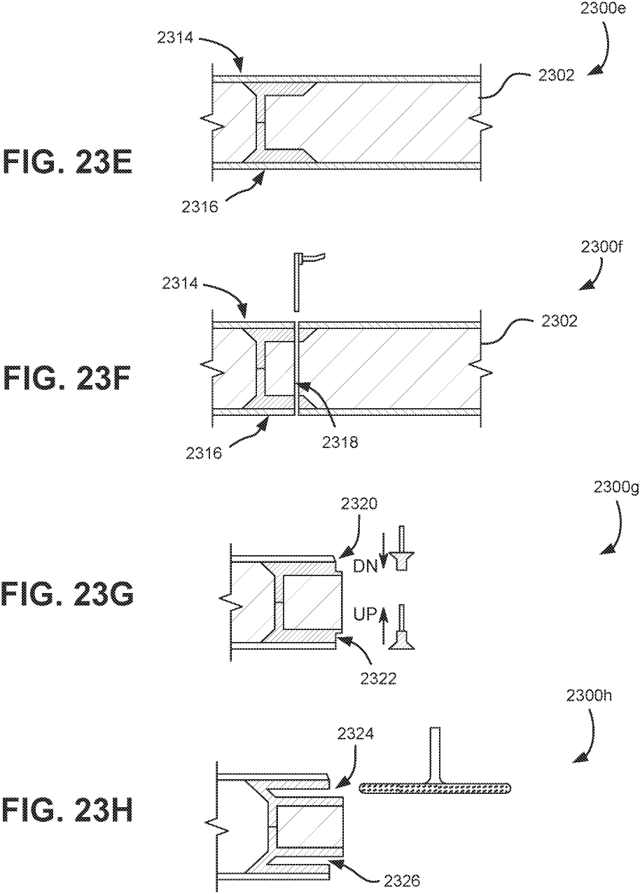

FIGS. 23A-23H illustrate example stages 2300a-2300h in an example process to form a sub-dermal edge with internal connecting elements. In some cases, one or more stages may be omitted, or other stages added. As illustrated in stage or view 2300a, a first cavity or recess 2304 may be excavate or milled out of a panel of core material 2303. Next, in view 2300b, a deeper cavity or recess may be excavated out of core material 2302, such as aligned with cavity 2304. In view 2300c, the cavity 2304, 2306 may be filled, such as with a reinforced fiber material 2308, to for part of a subdermal edge. In some examples, the excess fill may be milled, sanded, or otherwise removed, via a tool 2310. In some cases, view 2300d may show the same example steps being performed on the other side of core material 2302, such as by excavating another recess 2312 from the other side of core material 2302, to form a symmetric recess or cavity that spans a thickness of the core material 2302. The resulting recess 2312 and part of recess 2306 may then be filled with the same filler material.

View 2300e illustrates the core material 2302 with upper and lower skins 2314, 2316 attached. Next, in view 2300f, the skins 2314, 2316 and core 2302 may be trimmed to form an edge 2318 of the panel. In view 2300g, the resulting edge 2318 may be notched 2320, 2322 on the ends, in some cases, and slots 2324, 2326 cut into the filled portions, as illustrated in view 2300h.

### Example of Manufacturing of an Infused Reinforced Sub-Dermal edge

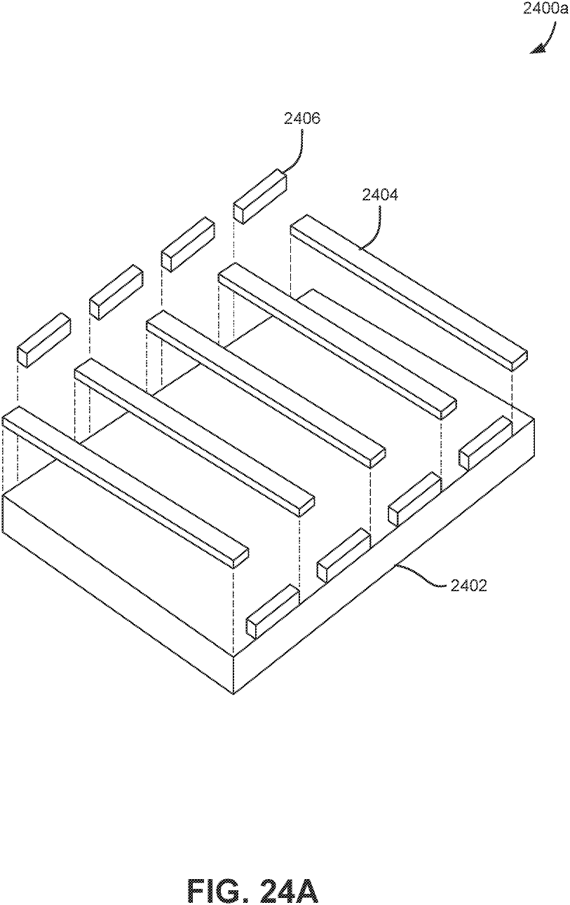

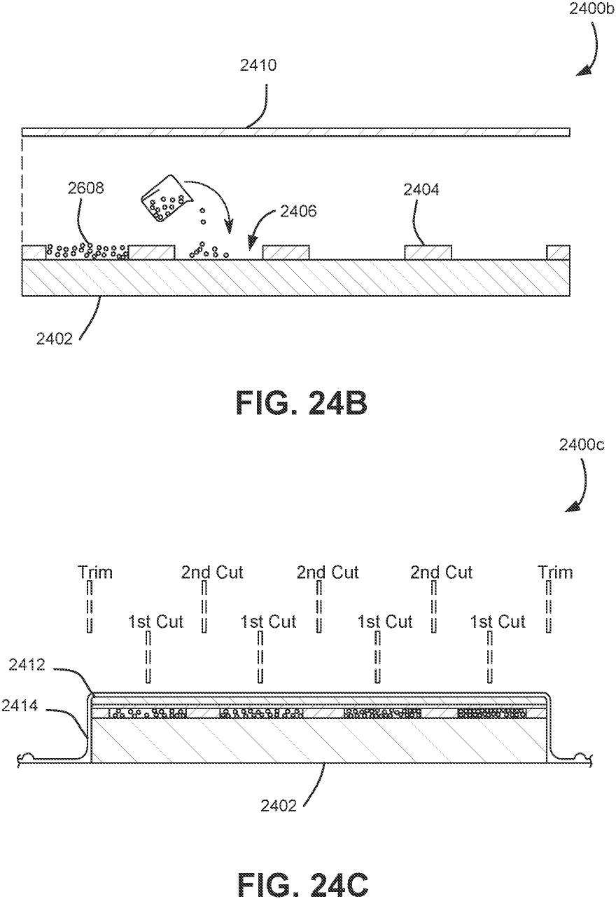

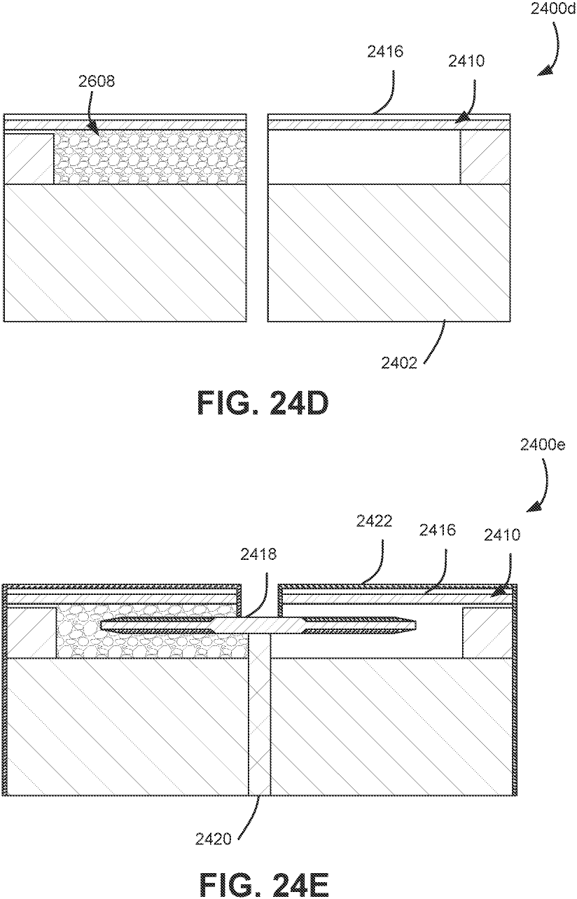

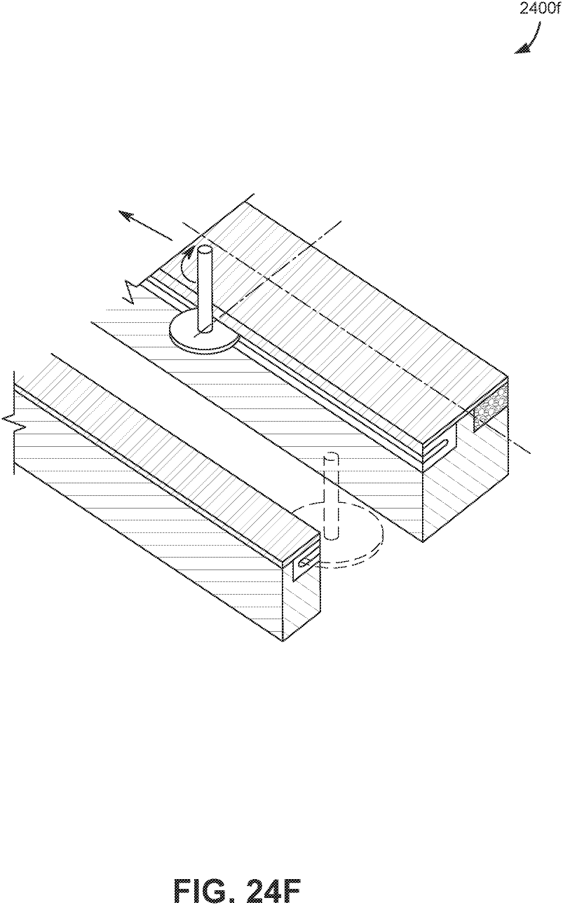

FIGS. 24A-24F illustrate example stages in an example process to form an infused reinforced sub-dermal edge. In some examples, diagrams 2400a-2400f of FIGS. 24A-24F may illustrate an example sequential step-by-step manufacturing protocol for liquid, paste or semi-solid infill into cavitated core, where the solidified sub-dermal mass can be cut, milled or routed to establish a cavitated sub-dermal edge block with connecting elements ready for structural connectors to be inserted into and attached to the cavities. Diagrams 2400a-2400f illustrate a manufacturing sequence of a cavity filled with reinforcing material such as glass or carbon beads or other suitable filler, overlaid by fiber sheet material that the filler supports against slumping under gravity or vacuum bag. A vacuum bag over the entire assembly allows infusion of skin and edge (inner and outer panel faces) as a single operation, offering economy.

Diagram 2400a illustrates balsa or other strips and sections 2404,2406 being added to a core 2402, which in some examples, may also be made of balsa wood. Diagram 2400b illustrates the core 2402 and strips 2404 from a side view, where the recesses 2406 are filled with a type of reinforcing material 2608, such as syntactic beads, to flatten an upward facing surface of the panel structure, to accept a skin element 2410. Diagram 2400c illustrates a finishing layer 2412 placed on top of the skin element 2410, and a vacuum bag 2414 placed over that, to enable a series of cuts to be made from above the core 2402.

Diagram 2400d and 2400e illustrate the sub-dermal cavity after infusion where resin 2416 inundates the fiber-reinforced skin 2410 as well as the voids in the filler material of glass or carbon beads or other suitable filler. Diagram 2400e illustrates an additional finishing paint (e.g., intumescent paint) 2422 applied to the outside of resin layer 2416, with biscuit 2418 inserted into slit formed in the resin or reinforced material 2608, with an adhesive 2420 applied in the middle of the j oint between the cores of the two panels. The fiber-reinforced composite skin and the sub-dermal filler in the cavity are inundated by a matrix (such as a polymer resin or other suitable matrix) to form a coherent integrated composite structural material. Infusion offers speed of fabrication as resin flows through all structural fiber-reinforced skins and bead-reinforced edges rapidly under vacuum, balancing both sides of the panel to minimize differential shrinkage and warping, and attaining a robust and well-integrated edge-skin continuous edge, minimizing risk of damage and delamination. Diagram 2400f shows a perspective milling step for forming the slots in the reinforced material.

### Example Fabricaiton Processes for Building Panel

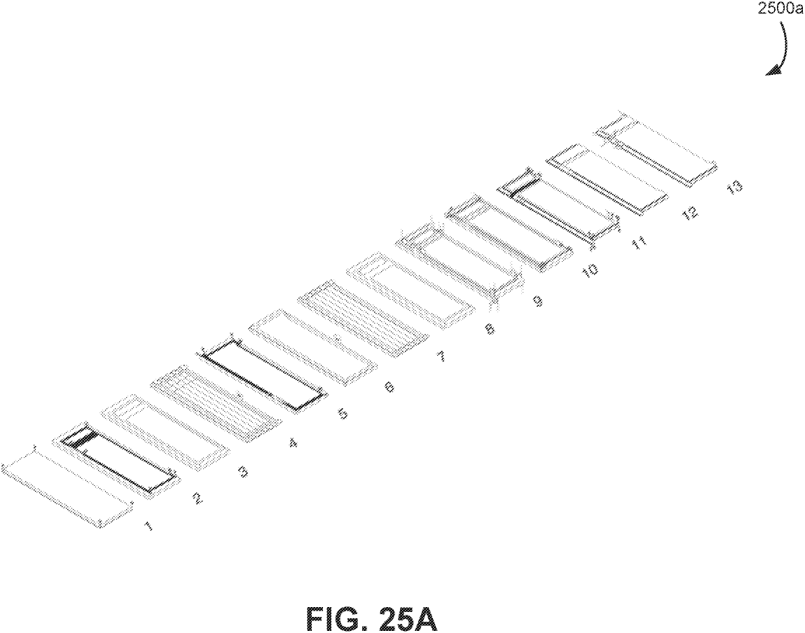

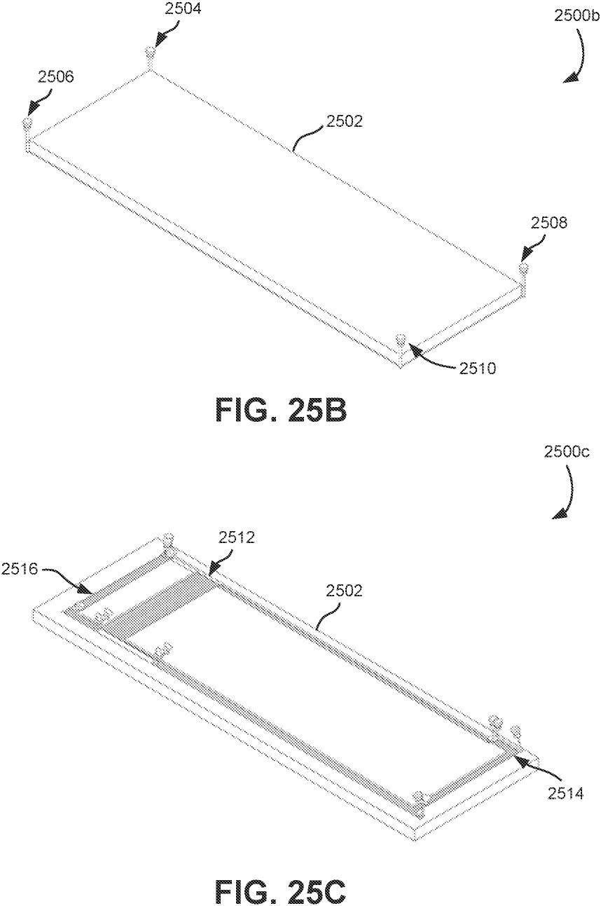

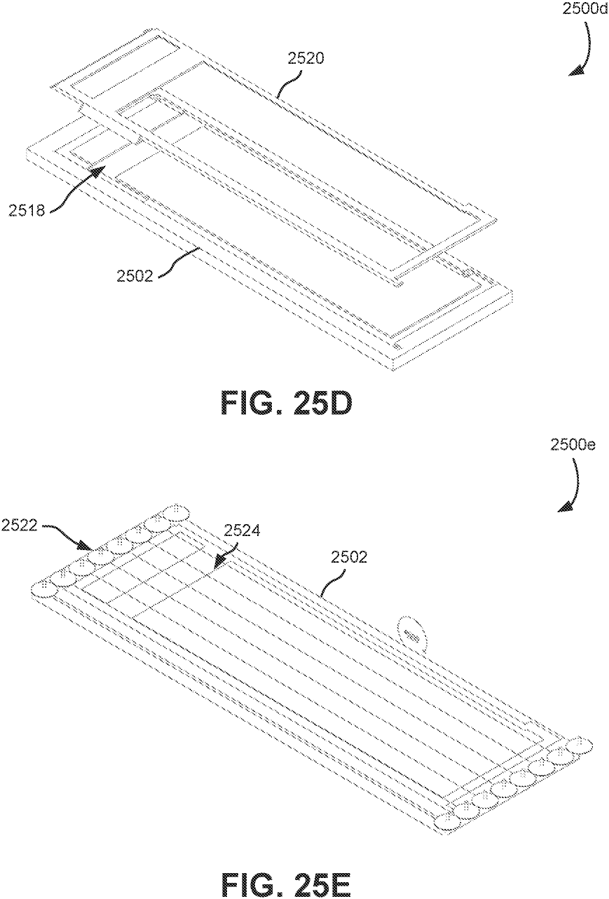

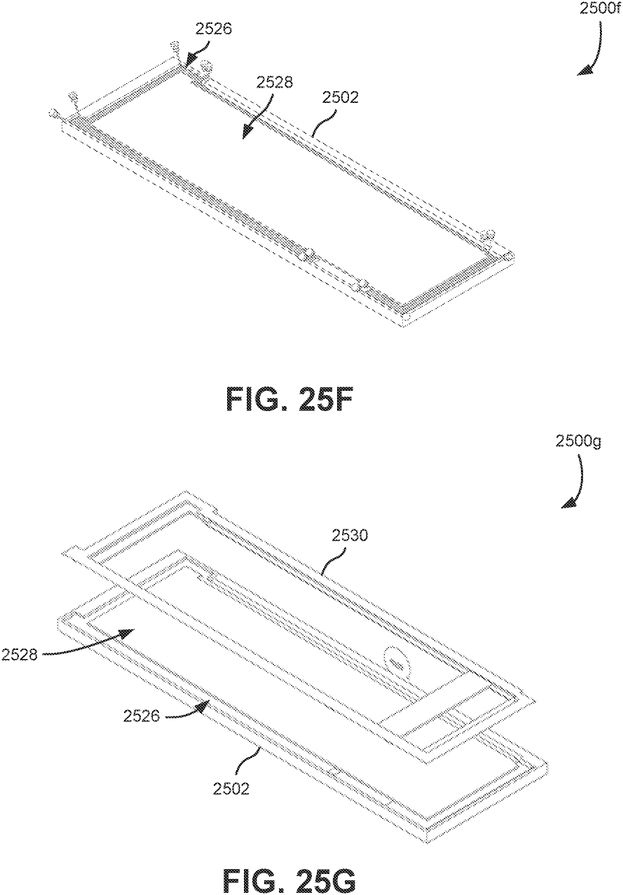

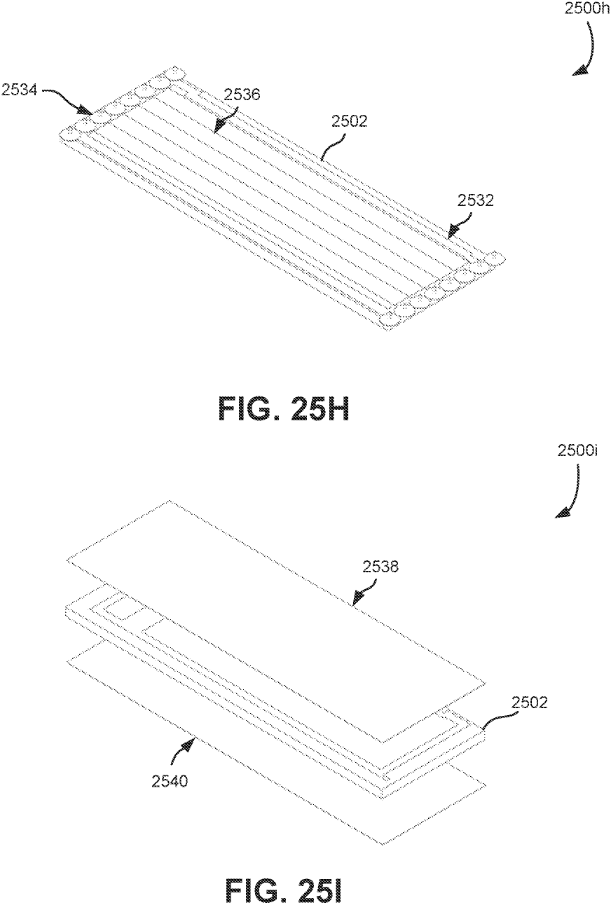

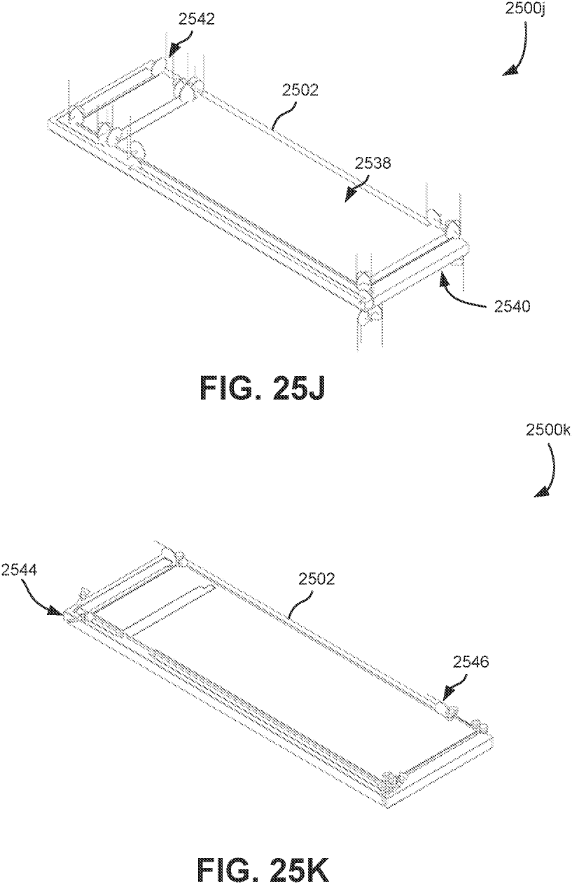

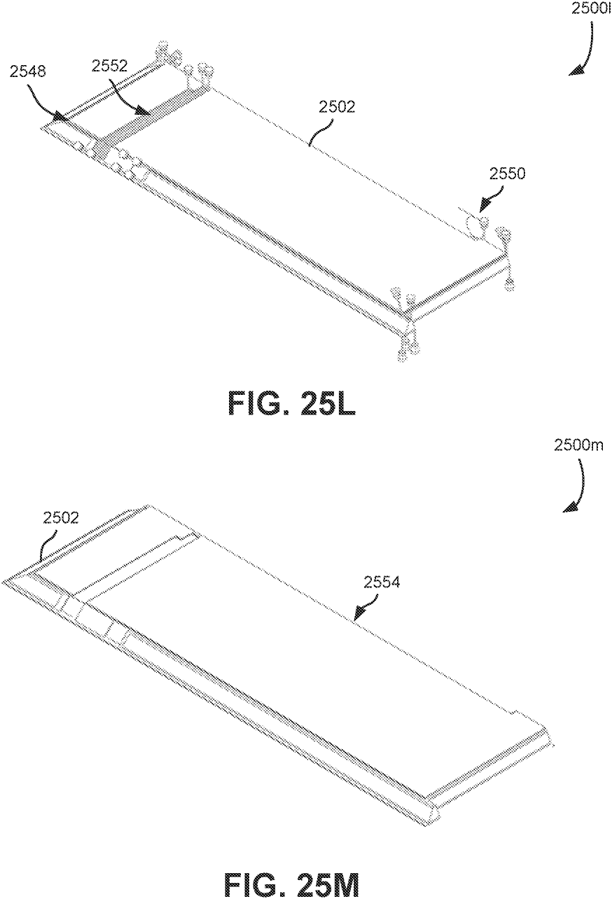

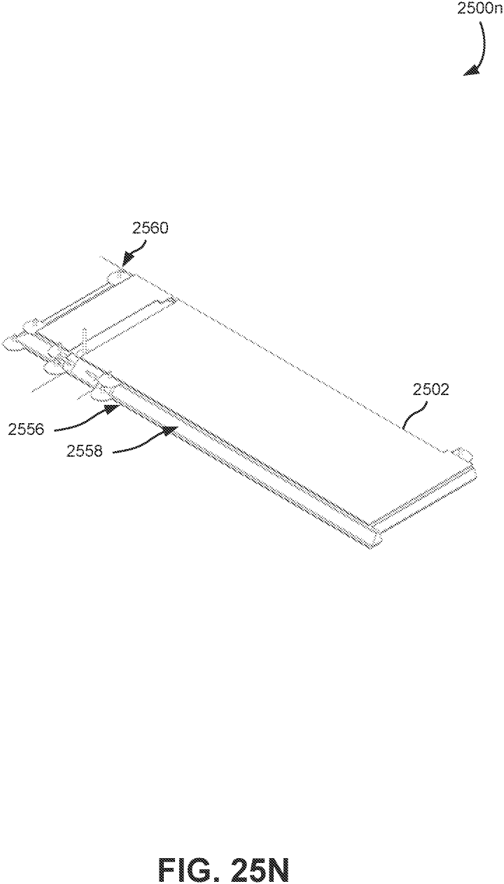

FIG. 25A illustrates a high-level diagram 2500a including multiple stages 1-13 of a fabrication or manufacturing process to form a composite panel, according to the techniques described herein. FIGS. 25B-25N illustrate each of the multiple stages of an example manufacturing process. The various embodiments of planar structural composite panels herein described can lend themselves in some examples to a prescribed sequence of manufacturing steps that can allow their production to be to a large degree automated or quasi-automated (or made by hand) using numeric command milling machines or similar mechanical equipment that can precisely cut, rout, trim large-format composite panels. In the example diagram 2500a illustrated in FIG. 25A, there can be anywhere from 10-20 discrete steps in the manufacture of a panel using these methods, although a higher or lower number of steps is possible. These steps can include additive and/or subtractive manufacture, either removing material or adding material according to need or as desired, building up specific property in each location to suit the performance needed or desired at that area of the eventual building or for other suitable purposes.

FIG. 25B illustrates an example starting point or first step 2500b. Diagram 2500b illustrates an example of an oversized motherboard 2502 of core material that is trimmed (e.g., to ensure it is perfectly square and to the required dimension to allow accurate placement on a machining table), as indicated by tools 2504-2510. In some cases, many panels could be nested on one motherboard to offer efficiency of manufacture.

FIG. 25C illustrates a next step 2500c in a process for manufacturing a composite panel. Diagram 2500c illustrates an example where recesses 2512, 2514, 2516 (indicated by shading) are excavated in the upper face of the core 2502 where other core materials or sub-dermal edge material can be located. In some cases, the recesses can be slightly oversized to allow tolerance when trimming later. The shading of recesses 2512, 2514, 2516 show toolpaths, which can vary depending on the tool used to excavate the core material.

FIG. 25D illustrates a next step 2500d in a process for manufacturing a composite panel. Diagram 2500d illustrates an example where recesses 2518 excavated in the upper face of the core 2502 are filled with core materials and liquid, semi-liquid or solid materials 2520 that can form solid sub-dermal edges that can be continuous around all edges of the polygonal panels, taking on the shapes needed or desired in that location, for instance at 45 degrees slope where panels meet at 90 degrees. In some locations the sub-dermal material can be shallow in depth, but at edges where the panel end does not link to other panels it can extend in depth to encapsulate the core (e.g., fully).

FIG. 25E illustrates a next step 2500e in a process for manufacturing a composite panel. Diagram 2500e illustrates an example where the entire core 2502 with infilled sub-dermal material can be fly-milled or sanded (indicated by different locations of one or more tools 2522 that can pass over the surface of the sub-dermal material indicated by lines 2524) to be (e.g., perfectly) flat for application of a fiber-reinforced skin. In some cases, the core panel 2502 can then be flipped for sub-dermal infill on the other face. In the illustrated example, tool 2522 may be a diamond-encrusted disc performing the sanding, but other tools may be used.

FIG. 25F illustrates a next step 2500e in a process for manufacturing a composite panel. Diagram 2500e illustrates an example where recesses 2525 are excavated in the lower face 2528 of the core 2502 where other core materials or sub-dermal edge material needs or is desired to be located. In some cases, recesses 2525 may be slightly oversized to allow tolerance when trimming. Lines show toolpath, which can vary depending on the tool used to excavate the core material.

FIG. 25G illustrates a next step 2500g in a process for manufacturing a composite panel. Diagram 2500g illustrates an example where recesses 2525 excavated in the lower face 2528 of the core 2502 are filled with core materials and liquid, semi-liquid or solid materials 2530 that form solid sub-dermal edges that can be continuous around all edges of the polygonal panels, taking on the shapes needed or desired in that location, such as for instance at 45 degrees slope where panels meet at 90 degrees. In some locations, the sub-dermal material can be shallow in depth, but at edges where the panel end does not link to other panels it can extend in depth to encapsulate the core (e.g., fully).

FIG. 25H illustrates a next step 2500h in a process for manufacturing a composite panel. Diagram 2500h illustrates an example where the entire core 2502 with infilled sub-dermal material 2532 can be fly-milled or sanded (indicated by different locations of one or more tools 2534 that can pass over the surface of the sub-dermal material indicated by lines 2536) to be (e.g., perfectly) flat for application of a fiber-reinforced skin. In the illustrated example, tool 2534 may be a diamond-encrusted disc performing the sanding, but other tools may be used.

FIG. 25I illustrates a next step 2500i in a process for manufacturing a composite panel. Diagram 2500i illustrates an example where fiber-reinforced skins 2538, 2540 are (e.g., fully) bonded over their (e.g., entire) area to the multi-material core 2502 such that the skins 2538, 2540 overlap the sub-dermal material inserts. The skins 2538, 2540 can be adhesively bonded or via the resin matrix if an infusion, hand lay-up, pre-impregnation or other process can be used.

FIG. 25J illustrates a next step 2500j in a process for manufacturing a composite panel. Diagram 2500j illustrates an example where the fiber-reinforced skins 2538, 2540 are cleanly severed by a tool 2542 such as a diamond-encrusted router bit or disc or any other suitable tool, that cuts through the fibers and matrix into the supporting sub-dermal edge material, which can be below any edge.

FIG. 25K illustrates a next step 2500k in a process for manufacturing a composite panel. Diagram 2500k illustrates an example where the edges 2544 of the panel 2502 are severed using a saw, a disc or an endmill or any other tool 2546, cutting through almost to the lower fiber-reinforced skin or through the lower fiber-reinforced skin (e.g., if the tool is capable of cleanly severing the fibers and the sub-dermal edge material). These cuts, which may be at different angles according to the geometry needed at the particular location of the panel, can result in an accurate overall panel geometry where some or all fiber-reinforced skin edges are bonded (e.g., robustly) to a sub-dermal edge material strip. In some embodiments, care should be taken to apply downward or upward pressure to the upper and lower skins respectively to prevent de-bonding from the sub-dermal core during cutting, routing, etc.

FIG. 25L illustrates a next step 2500l in a process for manufacturing a composite panel. Diagram 2500l illustrates an example where details 2548 can be excavated from the rough panel form 2502 using appropriate tools 2550 to attain finessed details as needed or desired in a given location. The toolpaths 2552 shown may vary according to different tools used to perform these detail operations.

FIG. 25M illustrates a next step 2500m in a process for manufacturing a composite panel. Diagram 2500m illustrates an example of one or more finishes 2554, such as wood or ceramic veneer, being applied to the panel 2502. In some cases, the one or more finishes 2554 may include intumescent or finish paint. In some cases, the finishing layer(s) 2554 can extend around the edges of the sub-dermal edge material to (e.g., fully) encapsulate the severed fiber-reinforced skin and sub-dermal edge, which in some examples can offer protection and aesthetic finesse.

FIG. 25N illustrates a next step 2500n in a process for manufacturing a composite panel. Diagram 2500n illustrates an example where a continuous cavity 2556 can be excavated from the upper and lower sub-dermal mass 2558 to a standard depth and profile at a fixed dimension below the fiber-reinforced skins. In some examples, a diamond-encrusted disc 2560 may be an appropriate tool with a shaped profile that matches the internal shape of the cavity in some examples, but any suitable tool may be used. This can mill through any finishes that may cover the sub-dermal mass, which in some examples can ensure that those finishes extend to the edge of the structural jointing element when it is inserted into the cavity in the sub-dermal mass. At internal corners the cavity describes a circular sweep to maintain the depth consistent along the entire edge of the polygonal, multi-edge panel.

In various embodiments, a process for creating a building panel may include some or all of the above steps. In some cases, one or more of the above stages may be omitted to produce the panel. In some cases, there may be one or more additional steps, for example according to the complexity of a given panel, and the degree of supplemental finishing or detail that a given building might require or for other suitable purpose.

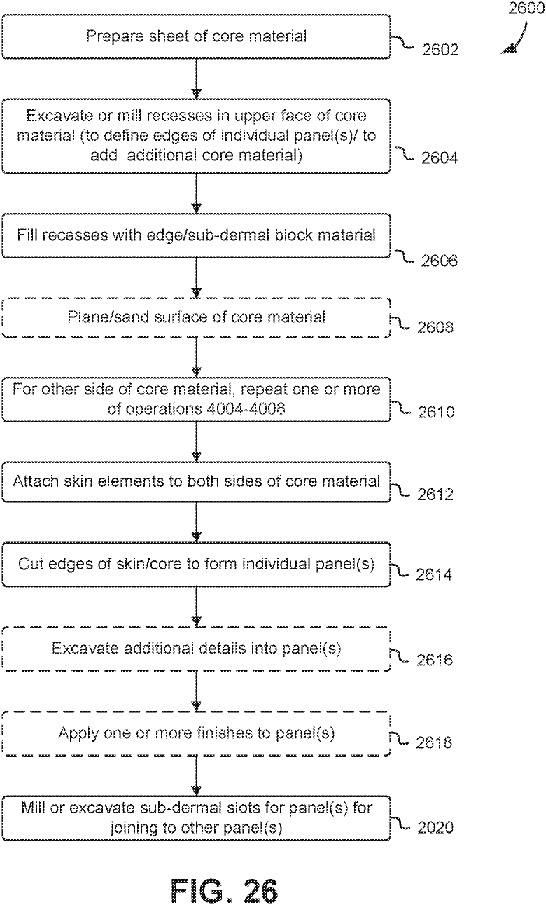

FIG. 26 illustrates an example process 2600 for constructing a building panel, such as may include none or more of stages 2600b-2600n described above. As used herein, dashed lines indicating a certain operation may signify that that operation is optional, such that process 2600 may be performed with or without the so-indicated operation(s). Operations 2602-2620 may correspond to the operations and example stages 2600b-2600n described above.

In some examples, process 2600 may begin at operation 2602, in which a sheet of core material may be prepared for fabrication of one or more building panels. Operation 2602 may include cutting the sheet to a size usable by a milling or other machinery. Next, at operation 2604, one or more areas or channels may be excavated from the upper face of the core material, where the excavated sections define boundaries of the one or more panels. In some cases, portions of the core material may be excavated for other purposes, such as to add one or more different materials to the core material, to provide different attributes (e.g., insulating properties, fire retardant properties, acoustical properties, and the like).

Next, at operation 2606, one or more of the recesses may be filled with a reinforced material, such as any of a variety of types of fiber reinforced material. In some cases, the material used to fill the recesses may be in liquid form; yet in other cases, the material used may take a semi-solid or solid form. Next, in some optional cases, the surface of the core may be sanded, milled, or otherwise processed to form a flat planar surface, for attachment of skin elements to the core material, at operation 2608. In various cases, one or more of operations 2604-2608 may be repeated for the other side of the core material, at operation 2610. In some cases, processes may only need to be performed on one side of the core material, such as where only one slot is formed in the sub-dermal edge of a given panel, for use with a single planar joining element. In cases where two planar joining elements are used for a given edge of at least one of the panels to be extracted from the sheet of core material, then at least operation 2604 and 2606 may be performed for the other side of the core material sheet.

The skin elements (e.g., sheets of some type of fiber reinforced material), may then be attached to both sides of the core material, at operation 2612. Edges may then be cut or milled (e.g., in one or multiple stages to cleanly cut skin and core materials, for example), to form one or more individual building panels from the larger sheet, at operation 2614. In some optional cases, other details may be excavated from one or both planar surfaces (or any of the edges) of the resulting one or more panels, at operation 2616. In some optional cases, one or more finishes, such as paint or coating material, thin veneer skin, such as wood or composite, may then be applied to one or both of the planar sides of the one or more panels (and/or edges) at operation 2618. Finally, one or more sub-dermal edges (e.g., slots or cavities as described above), may then be excavated, milled, or otherwise formed in one or more edges of the resulting panel(s).

### Example Manufacturing Facility

In various embodiments, step-by-step fabrication logic allows for automated or quasi-automated production (e.g., in some cases supplemented by-hand production) down an assembly line where dedicated equipment at each stage completes a set of given tasks that build towards a highly integrated planar composite panel. In some embodiments, such equipment is digitally controlled, and the panels can be entirely non-standard, allowing any suitable dimension, thickness and shape, and allowing any suitable joint typology. This in various embodiments can offer versatility of building form, with the specific geometries fed into the manufacturing protocol.

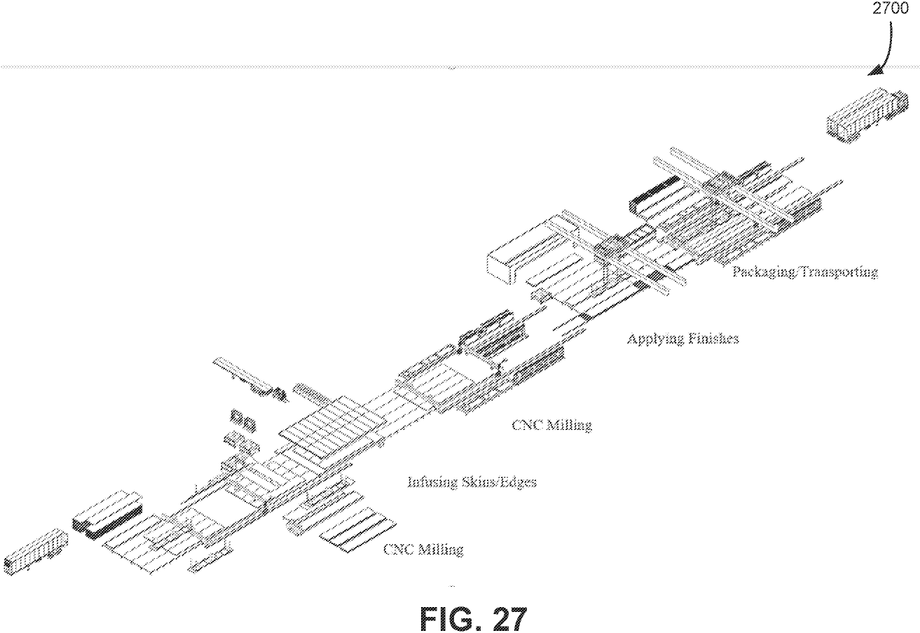

FIG. 27 illustrates an example diagram 2700 of a small automated production line for manufacturing the described building panels, such as using infusion methods. In some cases, the automated production line illustrated in FIG. 27 may include the following stages: core preparation, CNC or other milling, infusion of skins and/or edges, CNC or other milling, and applying one or more finishes.

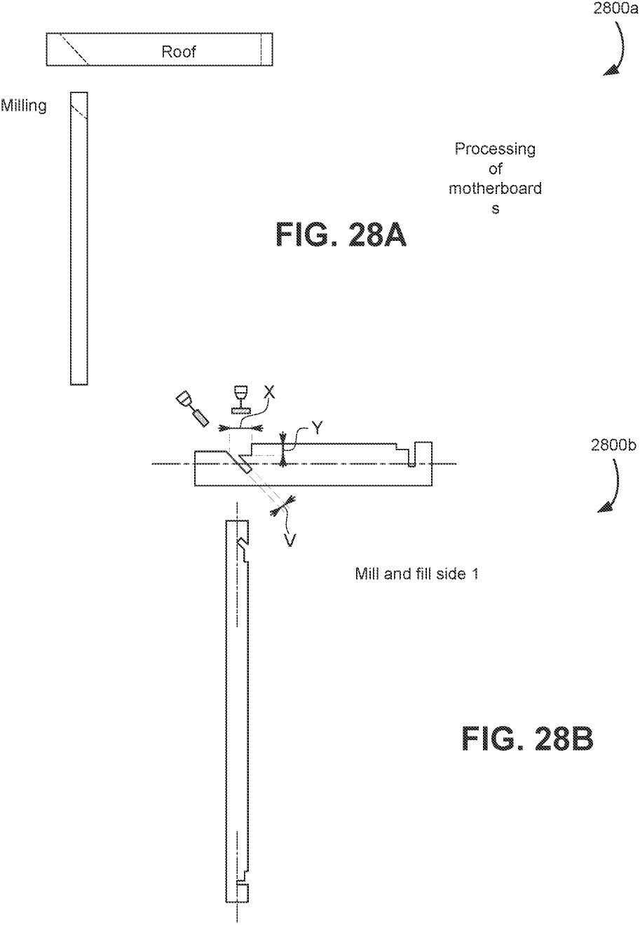

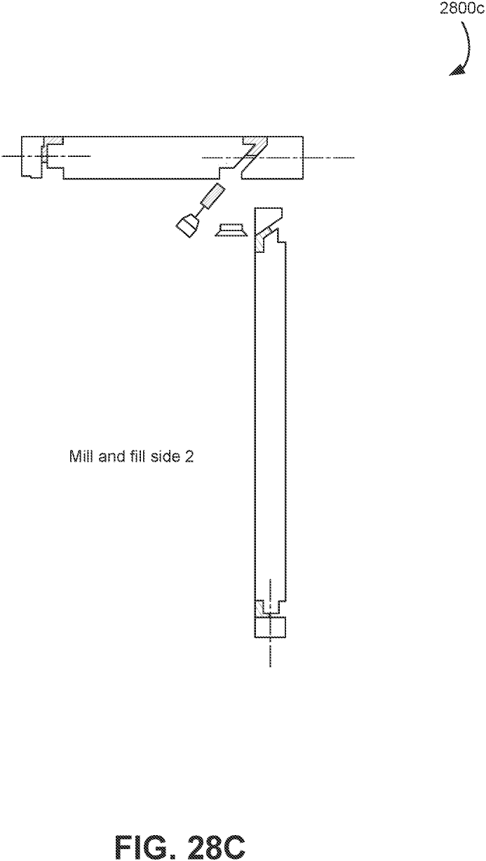

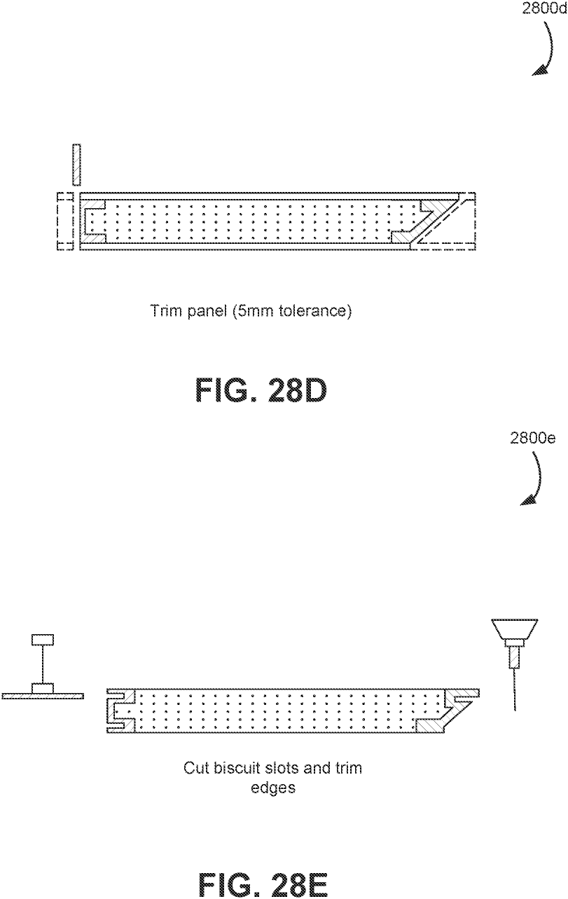

FIGS. 28A-28E illustrate example stages 2800a-2800e in an example fabrication process to form edges of two panels. As illustrated in view/stage 2800a, two motherboards 2802, 2804 may be selected and prepared for milling. Next, in view/stage 2800b, a first side 2806, 2808 of the panels 2802, 2804 may be milled, such as to form 45-degree edges 2810, 2812. Next, in view/stage 2800c, a second side 2814, 2816 of the panels 2802, 2804 may be milled. In view/stage 2800d, the panels 2802, 2804 may be trimmed, such as to a 5 mm tolerance. Next, at view/stage 2800e, the biscuit slots may be milled from the edges of panels 2802, 2804 and the edges may be trimmed and finished, such that the panels are not ready to be joined, such as using the joining element as described herein.

Embodiments of the present disclosure can be described in view of the following clauses:

1. A panelized building assembly, the assembly comprising:
a linear joining element comprising a first L-shaped channel substantially parallel to and spaced a first width apart from a second L-shaped channel, and a bridging element connecting the first L-shaped channel to the second L-shaped channel, wherein a first portion of the first L-shaped channel, a first portion of the second L-shaped channel, and the bridging element define a planar flange;
a first composite planar panel comprising a core material sandwiched between two first skin elements and a first edge, the first edge defining a first slot and a second slot within at least one first portion of reinforced material coupled to at least one of the first skin elements and between the first skin elements, wherein the first slot and the second slot are spaced the first width apart to accommodate receiving a second portion of the first L-shaped channel and a second portion of the second L-shaped channel; and
a second composite planar panel comprising a second core material sandwiched between two second skin elements, wherein a fist skin element of the two second skin elements at least partially defines a recess for receiving the planar flange of the linear joining element to secure and orient the first composite planar panel at an angle to the first skin element of the second composite planar panel.

2. The panelized building assembly of clause 1, wherein the bridging element comprises a third L-shaped structure that in part defines the planar flange.

3. The panelized building assembly of clause 2, wherein at least part of the first portion of the first L-shaped channel, the second portion of the first L-shaped channel, the first portion of the second L-shaped channel, the second portion of the second L-shaped channel, or the third L-shaped structure is rounded or angled at at least one corner to transfer load more evenly across the first composite planar panel and the second composite planar panel.

4. The panelized building assembly of any of clauses 1-3, wherein the recess comprises a T-shaped recess.

5. The panelized building assembly of any of clauses 1-4, wherein the second composite planar panel further comprises a portion of reinforced material proximate to the recess.

6. The panelized building assembly of any of clauses 1-5, wherein the recess spans substantially the length of the second composite planar panel.

7. The panelized building assembly of any of clauses 1-6, wherein at least one of the first portion of the first L-shaped channel, the second portion of the first L-shaped channel, the first portion of the second L-shaped channel, the second portion of the second L-shaped channel, or the third L-shaped structure is tapered.

8. The panelized building assembly of any of clauses 1-7, wherein the first portion of reinforced material of the first composite planar panel comprises two distinct portions of reinforced material each bonded to one of the first skin elements, each defining one of the first slot and the second slot.

9. The panelized building assembly of any of clauses 1-8, wherein the linear joining element comprises a fiber-reinforced material.

10. The panelized building assembly of any of clauses 1-9, wherein the core material of the first composite planar panel is completely enclosed by reinforced material.

11. The panelized building assembly of any of clauses 1-10, wherein upon securing the linear joining element to the recess of the second composite planar panel, a substantially waterproof and fire retardant joint between linear joining element to the recess of the second composite planar panel is formed.

12. The panelized building assembly of any of clauses 1-11, wherein the second composite planar panel comprises a second edge defining a third slot and a fourth slot within at least one second portion of reinforced material coupled to at least one of the second skin elements and between the second skin elements; and wherein the panelized building assembly further comprises:
a third composite planar panel comprising a third core material sandwiched between two third skin elements and a third edge defining a fifth slot and a sixth slot within at least one third portion of reinforced material coupled to at least one of the third skin elements and between the third skin elements; and
a sub-dermal joining element comprising a first planar joining element and a second planar joining element oriented substantially in parallel for use in coupling the second composite planar panel to the third composite planar panel, wherein the first planar joining element aligns with third slot and the fifth slot and the seconds planar joining element aligns with fourth slot and the sixth slot to secure the second composite planar panel to the third composite planar panel.

13. The panelized building assembly of clause 12, wherein upon joining the second composite planar panel and the third composite planar panel using the sub-dermal joining element, the resulting interface forms a substantially waterproof and fire-retardant joint.

14. A panelized building assembly, the assembly comprising:
a joining element comprising a first flanged section running a first length substantially parallel to and spaced a first width apart from a second flanged section running the first length, and a bridging element connecting the flanged section to the second flanged section, wherein the first flanged section, the flanged section, and the bridging element define a planar flange;
a first composite planar panel comprising a core material sandwiched between two first skin elements and a first edge, the first edge defining a first slot and a second slot within at least one first portion of reinforced material coupled to at least one of the first skin elements and between the first skin elements, wherein the first slot and the second slot are spaced the first width apart to accommodate receiving the joining element; and
a second composite planar panel comprising a second core material sandwiched between two second skin elements, wherein a fist skin element of the two second skin elements at least partially defines a recess for receiving the planar flange of the joining element to secure the first composite planar panel at an angle to the first skin element of the second composite planar panel.

15. The panelized building assembly of clause 14, wherein at least part of the first flanged section, the second flanged section, the bridging element, or the planar flange comprises at least one rounded or angled corner to transfer load more evenly across the first composite planar panel and the second composite planar panel.

16. The panelized building assembly of clause 15, wherein the recess comprises a T-shaped recess.

17. The panelized building assembly of clause 15 or 16, wherein the T-shaped recess is formed from a portion of reinforced material bonded to at least one of the first skin elements of the second composite planar panel.

18. The panelized building assembly of any of clauses 14-17, wherein at least one of the at least part of the first flanged section, the second flanged section, the bridging element, or the planar flange is tapered.

19. The panelized building assembly of any of clauses 14-18, wherein the first portion of reinforced material of the first composite planar panel comprises two distinct portions of reinforced material each bonded to one of the first skin elements, each defining one of the first slot and the second slot.

20. The panelized building assembly of any of clauses 14-19, wherein the first panel comprises a floor panel, and the second panel comprises a wall panel.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A panelized building assembly, the assembly comprising:
a linear joining element comprising a first L-shaped channel substantially parallel to and spaced a first width apart from a second L-shaped channel, and a bridging element connecting the first L-shaped channel to the second L-shaped channel, wherein a first portion of the first L-shaped channel, a first portion of the second L-shaped channel, and the bridging element define a planar flange;
a first composite planar panel comprising a core material sandwiched between two first skin elements and a first edge, the first edge defining a first slot and a second slot within at least one first portion of reinforced material coupled to at least one of the first skin elements and between the first skin elements, wherein the first slot and the second slot are spaced the first width apart to accommodate receiving a second portion of the first L-shaped channel and a second portion of the second L-shaped channel; and
a second composite planar panel comprising a second core material sandwiched between two second skin elements, wherein a fist skin element of the two second skin elements at least partially defines a recess for receiving the planar flange of the linear joining element to secure and orient the first composite planar panel at an angle to the first skin element of the second composite planar panel.

2. The panelized building assembly of claim 1, wherein the bridging element comprises a third L-shaped structure that in part defines the planar flange.

3. The panelized building assembly of claim 2, wherein at least part of the first portion of the first L-shaped channel, the second portion of the first L-shaped channel, the first portion of the second L-shaped channel, the second portion of the second L-shaped channel, or the third L-shaped structure is rounded or angled at at least one corner to transfer load more evenly across the first composite planar panel and the second composite planar panel.

4. The panelized building assembly of claim 1, wherein the recess comprises a T-shaped recess.

5. The panelized building assembly of claim 1, wherein the second composite planar panel further comprises a portion of reinforced material proximate to the recess.

6. The panelized building assembly of claim 1, wherein the recess spans substantially the length of the second composite planar panel.

7. The panelized building assembly of claim 1, wherein at least one of the first portion of the first L-shaped channel, the second portion of the first L-shaped channel, the first portion of the second L-shaped channel, the second portion of the second L-shaped channel, or the third L-shaped structure is tapered.

8. The panelized building assembly of claim 1, wherein the first portion of reinforced material of the first composite planar panel comprises two distinct portions of reinforced material each bonded to one of the first skin elements, each defining one of the first slot and the second slot.

9. The panelized building assembly of claim 1, wherein the linear joining element comprises a fiber-reinforced material.

10. The panelized building assembly of claim 1, wherein the core material of the first composite planar panel is completely enclosed by reinforced material.

11. The panelized building assembly of claim 1, wherein upon securing the linear joining element to the recess of the second composite planar panel, a substantially waterproof and fire retardant joint between linear joining element to the recess of the second composite planar panel is formed.

12. The panelized building assembly of claim 1, wherein the second composite planar panel comprises a second edge defining a third slot and a fourth slot within at least one second portion of reinforced material coupled to at least one of the second skin elements and between the second skin elements; and wherein the panelized building assembly further comprises:
a third composite planar panel comprising a third core material sandwiched between two third skin elements and a third edge defining a fifth slot and a sixth slot within at least one third portion of reinforced material coupled to at least one of the third skin elements and between the third skin elements; and
a sub-dermal joining element comprising a first planar joining element and a second planar joining element oriented substantially in parallel for use in coupling the second composite planar panel to the third composite planar panel, wherein the first planar joining element aligns with third slot and the fifth slot and the seconds planar joining element aligns with fourth slot and the sixth slot to secure the second composite planar panel to the third composite planar panel.

13. The panelized building assembly of claim 12, wherein upon joining the second composite planar panel and the third composite planar panel using the sub-dermal joining element, the resulting interface forms a substantially waterproof and fire-retardant joint.

14. A panelized building assembly, the assembly comprising:
a joining element comprising a first flanged section running a first length substantially parallel to and spaced a first width apart from a second flanged section running the first length, and a bridging element connecting the flanged section to the second flanged section, wherein the first flanged section, the flanged section, and the bridging element define a planar flange;
a first composite planar panel comprising a core material sandwiched between two first skin elements and a first edge, the first edge defining a first slot and a second slot within at least one first portion of reinforced material coupled to at least one of the first skin elements and between the first skin elements, wherein the first slot and the second slot are spaced the first width apart to accommodate receiving the joining element; and
a second composite planar panel comprising a second core material sandwiched between two second skin elements, wherein a fist skin element of the two second skin elements at least partially defines a recess for receiving the planar flange of the joining element to secure the first composite planar panel at an angle to the first skin element of the second composite planar panel.

15. The panelized building assembly of claim 14, wherein at least part of the first flanged section, the second flanged section, the bridging element, or the planar flange comprises at least one rounded or angled corner to transfer load more evenly across the first composite planar panel and the second composite planar panel.

16. The panelized building assembly of claim 15, wherein the recess comprises a T-shaped recess.

17. The panelized building assembly of claim 15, wherein the T-shaped recess is formed from a portion of reinforced material bonded to at least one of the first skin elements of the second composite planar panel.

18. The panelized building assembly of claim 14, wherein at least one of the at least part of the first flanged section, the second flanged section, the bridging element, or the planar flange is tapered.

19. The panelized building assembly of claim 14, wherein the first portion of reinforced material of the first composite planar panel comprises two distinct portions of reinforced material each bonded to one of the first skin elements, each defining one of the first slot and the second slot.

20. The panelized building assembly of claim 14, wherein the first panel comprises a floor panel, and the second panel comprises a wall panel.
